(19) United States
(12) Patent Application Publication
(10) Pub. No.: US 2010/0189464 A1
(43) Pub. Date: Jul. 29, 2010

(54) DEVELOPER, DEVELOPER CARTRIDGE, DEVELOPMENT DEVICE, AND IMAGE FORMING APPARATUS

(75) Inventor: Yuki MATSUURA, Tokyo (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: OKI DATA CORPORATION, Tokyo (JP)

(21) Appl. No.: 12/691,080

(22) Filed: Jan. 21, 2010

(30) Foreign Application Priority Data
Jan. 23, 2009 (JP) 2009-013137

(51) Int. Cl. G03G 15/08; G03G 9/10

(52) U.S. Cl. 399/119; 430/110.4

(57) ABSTRACT

A developer includes a toner including a toner mother particle having a resin and a colorant and an external additive to be added to a surface of the toner mother particle. The toner has a volume average particle size of greater than or equal to 3.0 μm and smaller than or equal to 7.0 μm and has a surface roughness Rzjis of greater than or equal to 75.3 nm and smaller than or equal to 236.9 nm under observation using a scanning probe microscope. The external additive is titanium oxide having a particle size of greater than or equal to 10 nm and smaller than or equal to 100 nm.

### BACKGROUND OF THE INVENTION

1. Field of the Invention

The present invention relates to developer used for such as a copier, a facsimile machine, and a printer. The present invention also relates to a developer cartridge, a development device, and an image forming apparatus.

2. Description of Related Art

An image forming apparatus employing an electrophotographic method generally forms an image by a series of image forming processes including: a charging process uniformly charging an image carrier having a photoconductive insulation layer; an irradiation process irradiating the photoconductive insulation layer, so that a potential on the irradiated portion is attenuated to form a latent image; a development process visualizing the latent image by adhesion of toner as developer including at least a resin and a colorant through a development roller; a transfer process transferring the visualized image, or namely a toner image, to a recording medium such as a transfer sheet; and a fixing process fixing the transferred toner image onto the recording medium by application of heat, pressure or other suitable fixing methods.

The toner used for the image forming apparatus forming the image by the electrophotographic method is generally produced by adhesion of an external additive to toner mother particles made of such as a pigment, resin, wax, and a charge control agent. Conventionally, titanium oxide is used as the eternal additive to be adhered to the toner mother particles (see, e.g., Japanese Un-examined Patent Application Publication No. 2006-84768).

In a case where the image forming apparatus storing the toner therein resumes the image forming processes after halting the processes for a lengthy period of time, the titanium oxide is released from the toner and adhered to a development roller, causing deterioration of image quality.

The present invention has been made to reduce the occurrences of deterioration of image quality.

### BRIEF SUMMARY OF THE INVENTION

According to an aspect of the present invention, a developer includes a toner including a toner mother particle having a resin and a colorant and an external additive to be added to a surface of the toner mother particle. The toner has a volume average particle size of greater than or equal to 3.0 μm and smaller than or equal to 7.0 μm and has a surface roughness Rzjis of greater than or equal to 75.3 nm and smaller than or equal to 236.9 nm under observation using a scanning probe microscope. The external additive is titanium oxide having a particle size of greater than or equal to 10 nm and smaller than or equal to 100 nm.

According to another aspect of the present invention, a developer cartridge includes a developer container storing therein a toner including a toner mother particle having a resin and a colorant and an external additive to be added to a surface of the toner mother particle. The toner has a volume average particle size of greater than or equal to 3.0 μm and smaller than or equal to 7.0 μm, and has a surface roughness Rzjis of greater than or equal to 75.3 nm and smaller than or equal to 236.9 nm under observation using a scanning probe microscope. The external additive is titanium oxide having a particle size of greater than or equal to 10 nm and smaller than or equal to 100 nm.

According to another aspect of the present invention, a development device includes: a developer cartridge storing a developer; and a development device main body including a developer carrier carrying the developer supplied from the developer cartridge and an image carrier provided with the developer supplied from the developer carrier. The developer includes a toner having a toner mother particle having a resin and a colorant and an external additive to be added to a surface of the toner mother particle. The toner has a volume average particle size of greater than or equal to 3.0 μm and smaller than or equal to 7.0 μm, and has a surface roughness Rzjis of greater than or equal to 75.3 nm and smaller than or equal to 236.9 nm under observation using a scanning probe microscope. The external additive is titanium oxide having a particle size of greater than or equal to 10 nm and smaller than or equal to 100 nm.

According to another aspect of the present invention, an image forming apparatus includes: a development device forming a developer image, the development device including a developer cartridge storing a developer and a development device main body; a transfer unit transferring the development image formed by the development device to a recording medium; and a fixing unit fixing the development image transferred by the transfer unit onto the recording medium. The developer includes a toner having a toner mother particle having a resin and a colorant and an external additive to be added to a surface of the toner mother particle. The toner has a volume average particle size of greater than or equal to 3.0 μm and smaller than or equal to 7.0 μm, and has a surface roughness Rzjis of greater than or equal to 75.3 nm and smaller than or equal to 236.9 nm under observation using a scanning probe microscope. The external additive is titanium oxide having a particle size of greater than or equal to 10 nm and smaller than or equal to 100 nm.

Additional features and advantages of the present invention will be more fully apparent from the following detailed description of embodiments, the accompanying drawings and the associated claims.

### BRIEF DESCRIPTION OF THE DRAWINGS

A more complete appreciation of the aspects of the present invention and many of the attendant advantage thereof will be readily obtained as the same becomes better understood by reference to the following detailed description when considered in connection with the accompanying drawings, wherein:

FIG. 1 is a schematic diagram illustrating a printer serving as an image forming apparatus according to a first embodiment of the present invention;

FIG. 2 is a schematic diagram illustrating a development device in the printer of FIG. 1;

FIG. 3 is a schematic diagram illustrating a toner cartridge serving as a developer cartridge in the development device of FIG. 2;

FIG. 4A is a schematic diagram illustrating a correlation between a drum fog evaluation result and toner particle size and titanium oxide particle size in a case where the titanium oxide is blended with a certain amount;

FIG. 4B is a schematic diagram illustrating a correlation between a drum fog evaluation result and toner particle size and titanium oxide particle size in a case where the titanium oxide is blended with a certain amount;

FIG. 4C is a schematic diagram illustrating a correlation between a drum fog evaluation result and toner particle size and titanium oxide particle size in a case where the titanium oxide is blended with a certain amount; and

FIG. 4D is a schematic diagram illustrating a correlation between a drum fog evaluation result and toner particle size and titanium oxide particle size in a case where the titanium oxide is blended with a certain amount.

### DETAILED DESCRIPTION OF PREFERRED EMBODIMENTS

The present invention is now described more fully hereinafter with reference to the accompanying drawings, in which preferred embodiments of the present invention are shown. The present invention may, however, be embodied in many different forms and should not be construed as limited to the embodiments set forth herein. The embodiments, therefore, may be modified or varied without departing from the scope of the present invention.

In describing embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner. Preferred embodiments of the present invention are described in detail referring to the drawings, wherein like reference numerals designate identical or corresponding parts throughout the several views.

### First Embodiment

A description is given of a printer 100 serving as an image forming apparatus according to the present invention, followed by descriptions of a development device 20, a toner cartridge 30 serving as a developer cartridge, and a toner according to the present invention. The printer 100 performs image formation using the toner serving as a developer. The development device 20 includes: a development device main body 20a supplying the toner to a latent image formed on a latent image carrier to visualize the image; and the toner cartridge 30 storing the toner therein.

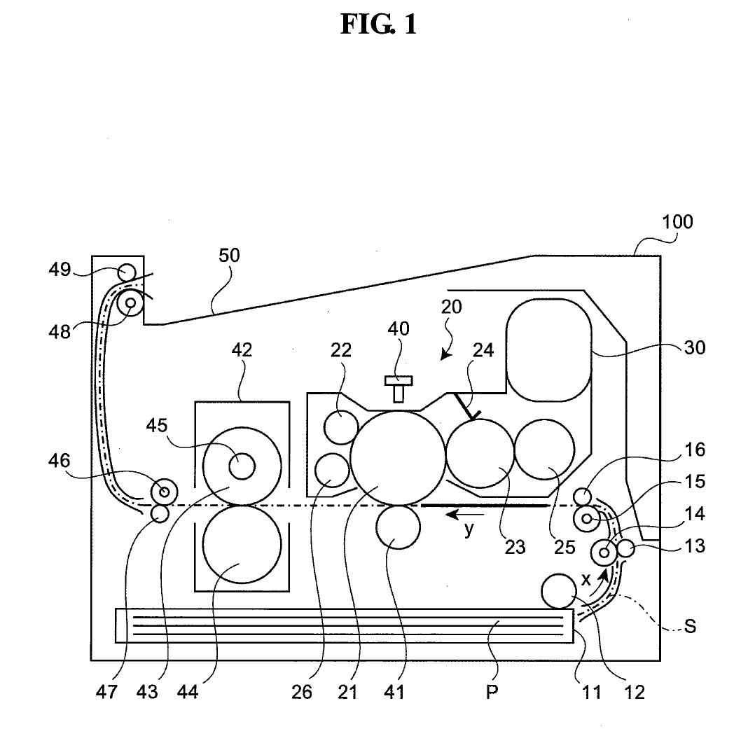

Referring to FIG. 1, the printer 100 serving as the image forming apparatus is illustrated. The printer 100 forms the image on a recording medium using an electrophotographic method. The printer 100 includes the development device 20 and a fixing device 42 along a sheet conveyance path S formed in a substantially letter S shape having a sheet cassette 11 disposed at a starting point thereof and an ejection roller 48 disposed at an ending point thereof. The printer 100 also includes conveyance rollers disposed along the sheet conveyance path S to convey a sheet P serving as the recording medium.

The sheet cassette 11 is detachably attached in a lower portion of the printer 100 in a state that the sheet P or sheets P are stacked therein. A hopping roller 12, disposed in an upper portion of the sheet cassette 11, separates a plurality of sheets P sheet by sheet from a sheet P stacked on top, so that each of the sheets P is separately fed from the sheet cassette 11 in a direction “x” indicated by an arrow shown in FIG. 1.

A conveyance roller 13 forms a pair with a pinch roller 14 to sandwich and convey the sheet P fed by the hopping roller 12. A registration roller 15 forms a pair with a pinch roller 16, thereby correcting skew of the sheet P conveyed from the pair of the conveyance roller 13 and the pinch roller 14 and conveying the sheet P to the development device 20. Each of such rollers is rotated by the driving force transmitted from a drive motor (not shown) through, for example, a gear.

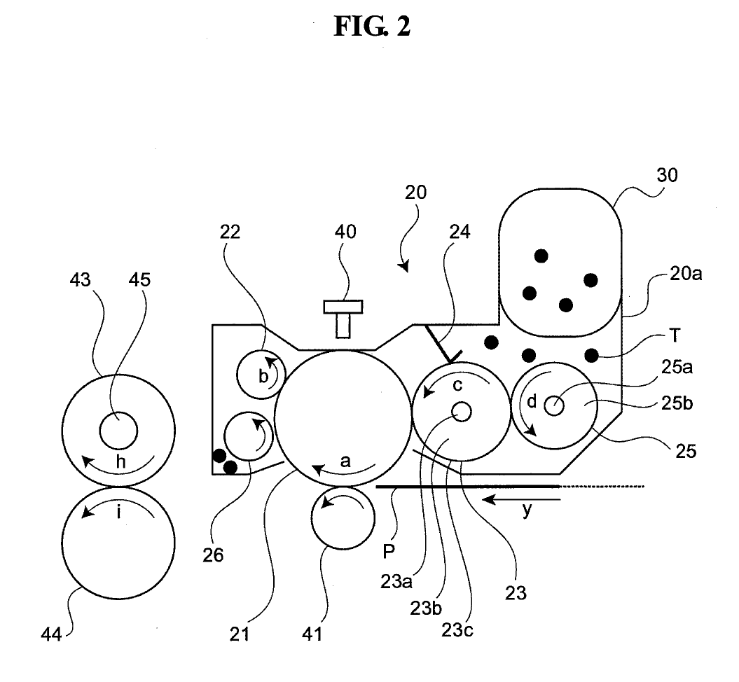

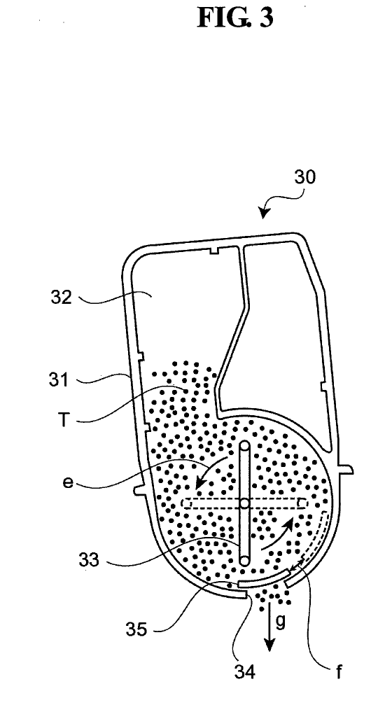

The development device 20 includes the development device main body 20a and the toner cartridge 30 serving as the developer cartridge. The development device 20 is detachably attached along the sheet conveyance path “S.” The development device 20 develops the latent image formed on a photosensitive drum 21 by adhesion of the toner, thereby forming a toner image by visualizing the latent image. Herein, the latent image is formed on the photosensitive drum 21 serving as the latent image carrier by irradiation of the light emitted from a light emitting diode (LED) head 40. A detailed description of the development device main body 20a and the toner cartridge 30 forming the development device 20 will be given later with reference to FIGS. 2, 3.

The toner cartridge 30, serving as the developer cartridge, includes a developer container storing, for example, a black toner therein and is detachably attached in a prescribed location of the development device main body 20a. A detailed description of the toner cartridge 30 is given later.

The LED head 40 includes, for example, LED elements and a lens array and is disposed in a position in such a manner that the irradiation light emitted from the LED elements forms the image on a surface of the photosensitive drum 21.

A transfer roller 41 is, for example, made of conductive rubber and is disposed in such a manner as to be opposite to and press the photosensitive drum 21. The transfer roller 41 is applied with the bias voltage from a transfer roller power source (not shown), thereby transferring the toner image developed on the photosensitive drum 21 by the development device 20 to the sheet P.

A fixing roller 42 is disposed on a downstream side relative to the development 20 in the sheet conveyance path “S,” and includes a heat roller 43, a backup roller 44, and a thermistor (not shown). The heat roller 43 includes a metal core having a cylindrical hollow structure, a heat-resistance elastic layer made of silicon rubber, and a tube made of tetrafluoroethylene-perfluoroalkyl vinyl ether copolymer (PFA). The metal core, for example, made of aluminum is covered with the heat-resistance elastic layer, and the heat-resistance elastic layer covering the metal core is covered with the PFA tube. The metal core, for example includes a heater 45 such as a halogen lamp thereinside. The backup roller 44, for example, includes a metal core covered with a heat-resistance elastic layer made of silicon rubber, and a PFA tube covering the heat-resistance elastic layer. The backup roller 44 is disposed in such a manner as to form a pressure-contact portion between the heat roller 43 and thereof. The thermistor, serving as a surface temperature detection mechanism, is disposed in the vicinity of the heat roller 43 in a non-contact manner to detect a surface temperature of the heat roller 43. The heater 45 is controlled based on the surface temperature of the heat roller 43 detected by the thermistor, so that the surface temperature of the heat roller 43 is maintained at a prescribed temperature. The sheet P having the toner image transferred thereon passes the pressure-contact portion formed between the backup roller 44 and the heat roller 43 maintained at the prescribed temperature, so that the toner on the sheet P is melted by application of heat and pressure, thereby fixing the toner image on the sheet P.

A conveyance roller 46 forms a pair with a pinch roller 47 to sandwich and convey the sheet P passed through the fixing device 42. An ejection roller 48 forms a pair with a pinch roller 49 to eject the sheet P conveyed from the pair of conveyance roller 46 and the pinch roller 47 on a sheet stacker 50. Herein, the sheet stacker 50 is formed using an external surface of a housing for the printer 100 and stacks thereon the sheet P ejected by the pair of the ejection roller 48 and the pinch roller 49.

In addition to the above, the printer 100 includes: a print control unit including a microprocessor, a read only memory (ROM), a random access memory (RAM), an input-output port, and a timer; an interface control unit controlling the sequence of the printer 100 as a whole by receiving print data and a control command to execute the printing operation; a reception memory temporarily storing therein the print data input through the interface control unit; an image data editing memory receiving the print data stored in the reception memory and storing therein image data formed by editing the print data; a display unit including a display device such as liquid crystal display (LCD) to display a state of the printer 100; an operation unit including an input mechanism such as a touch panel to receive an instruction from a user; various sensors such as a sheet position detection sensor, a temperature humidity sensor, a density sensor to monitor an operation state of the printer 100; a head drive control unit allowing the image data stored in the image data edit memory to be transmitted to the LED head 40 and controlling the drive of the LED head 40; a temperature control unit controlling the temperature of the fixing device 42; a sheet conveyance motor control unit controlling a drive motor rotating each of the rollers conveying the sheet P; a drive control unit controlling a drive motor rotating each of the rollers including the photosensitive drum 21; and a high voltage power source applying the voltage to each of the rollers.

A description is now given of the development device main body 20a with reference to a schematic diagram of FIG. 2.

The photosensitive drum 21 includes a conductive support member and a photoconductive layer. The photosensitive drum 21 serves as an organic photoreceptor and is formed by sequentially layering a charge transport layer and a charge generation layer serving as the photoconductive layer on a metal pipe, made of aluminum, serving as the conductive support member. A charging roller 22 is disposed to a circumference surface of the photosensitive drum 21 in a contact manner and includes a metal shaft and a semi-conductive epichlorohydrin rubber. A cleaning roller 26 is disposed in a prescribed position on the circumference surface of the photosensitive drum 21, thereby removing the toner remained on the photosensitive drum 21.

A development roller 23, serving as a developer carrier, is disposed in such a manner as to press the circumference surface of the photosensitive drum 21. The development roller 23 includes: a metal core 23a, serving as a metal shaft, made of stainless and the like; a conductive polyurethane rubber 23b including carbon black dispersed therein; and a surface layer 23c with an isocyanate treatment performed thereon. The conductive polyurethane rubber 23b serves as a conductive elastic member. A development blade 24, made of stainless, is disposed in a prescribed position on the circumference surface of the development roller 23 to regulate a thickness of a toner layer.

A sponge roller 25, serving as a developer supply member, is disposed in such a manner as to press the circumference surface of the development roller 23. The sponge roller 25 includes a metal shaft 25a and a semi-conductive foam silicone rubber layer 25b.

As illustrated in FIG. 2, the photosensitive drum 21 is rotated in a direction “a” indicated by an arrow shown in FIG. 2 at a constant speed by a drive motor (not shown). The charging roller 22, disposed to a circumference surface of the photosensitive drum 21 in a contact manner, applies a charging bias having a voltage of −1000 V supplied by a charging roller high voltage power source (not shown) to the surface of the photosensitive drum 21 while rotating in a direction “b” indicated by an arrow shown in FIG. 2, thereby uniformly charging the surface of the photosensitive drum 21. Subsequently, the LED head 40, disposed opposite to the photosensitive drum 21, irradiates the uniformly charged surface of the photosensitive drum 21 with the light corresponding to an image signal, so that a potential on an irradiated portion is attenuated, thereby forming a latent image. Herein, the portion irradiated by the LED head 40 has a drum potential having a voltage of −50 V, and a non-irradiated portion has a voltage of −500 V.

The development roller 23 is disposed to the photosensitive drum 21 in a close-contact manner, and is applied with a development bias having a voltage of −200 V by a development roller high voltage power source (not shown). The development roller 23 absorbs the toner conveyed by the sponge roller 25 applied with a supply voltage having −300 V and rotatably conveys the toner in a direction “c” indicated by an arrow shown in FIG. 2. In such a rotation conveyance process, the development blade 24, disposed to the development roller 23 in a pressure-contact manner on a downstream side relative to the sponge roller 25, regulates the thickness of the toner absorbed to the development roller 23, thereby forming the toner layer having a uniform thickness.

The development roller 23 reversely develops the latent image formed on the photosensitive drum 21 with the toner carried thereby. Since a portion between the conductive support member of the photosensitive drum 21 and the development roller 23 is applied with the bias voltage by the high voltage power source, the electric line of force associated with the electrostatic latent image formed on the photosensitive drum is generated. Accordingly, the charged toner on the development roller 23 is adhered to the latent image on the photosensitive drum 21 by the electrostatic force, so that the latent image is developed and visualized, thereby forming the toner image. Such a development process begins at a prescribed timing with beginning of the rotation of the photosensitive drum 21.

A description is now given of the toner cartridge 30 serving as the developer cartridge with reference to a schematic diagram of FIG. 3.

The toner cartridge 30 includes a container 31 having a developer container 32 storing therein a toner T serving as a one-component developer. An agitation bar 33, serving as an agitation member, extends in a longitudinal direction in a prescribed portion of the developer container 32 and is rotatably supported, thereby rotating in a direction “e” indicated by an arrow shown in FIG. 3. An outlet 34 is provided below the agitation bar 33 to discharge the toner T from the container 31. A shutter 35, serving as an open-close member, is disposed inside the container 31 and is slidable in a direction “f” indicated by an arrow shown in FIG. 3, thereby allowing the outlet 34 to be open and closed.

The shutter 35 slides in the direction “f” by a lever (not shown); that is, the shutter 35 slides in a direction in which the outlet 34 is open, after the toner cartridge 30 is attached to the development device main body 20a as illustrated in FIG. 2. Accordingly, the toner T inside the container 31 falls from the outlet 34 in a direction “g” indicated by an arrow shown in FIG. 3 and is supplied to the development device main body 20a as illustrated in FIG. 2. The toner T fallen to the development device main body 20a is supplied to the development roller 23 with rotation of the sponge roller 25 rotated in a direction “d” indicated by an arrow shown in FIG. 2 by the voltage applied by a sponge roller high voltage power source (not shown).

A description is now given of the image forming processes performed by the printer 100.

The plurality of sheets P stored inside the sheet cassette 11 are separately fed from the sheet cassette 11 sheet by sheet in the direction “x” by the hopping roller 12 as illustrated in FIG. 1. Subsequently, each of the sheets P is conveyed along the sheet conveyance path S to the development device 20 while the pair of the conveyance roller 13 and the pinch roller 14 and the pair of the registration roller 15 and the pinch roller 16 are correcting the sheet P being skewed. The development process described above begins at a prescribed timing during a period in which the sheet P is conveyed in a direction “y” indicated by an arrow shown in FIG. 2.

The transfer roller 41 performs the transfer process as illustrated in FIG. 2 by application of a transfer bias thereto by a transfer roller power source (not shown). The transfer roller 41 transfers the toner image formed on the photosensitive drum 21 by the above development process to the sheet P in the development process.

Subsequently, the sheet. P is conveyed to the fixing device including the heat roller 43 and the backup roller 44. The sheet P having the toner image transferred thereon is fed to a portion between the heat roller 43 rotated in a direction “h” indicated by an arrow shown in FIG. 2 and the backup roller 44 rotated in a direction “i” indicated by an arrow shown in FIG. 2. Herein, the surface temperature of the heat roller 43 is maintained at the prescribed temperature by being controlled by a temperature control mechanism (not shown). The toner T on the sheet P is melted by the heat of the heat roller 43 and is pressed in the pressure-contact portion formed between the heat roller 43 and the backup roller 44, thereby fixing the toner image onto the sheet P.

The sheet P having the toner image fixed thereon is conveyed by the pair of conveyance roller 46 and pinch roller 47, and is ejected on the sheet stacker 50 by the pair of ejection roller 48 and pinch roller 49.

After the toner image is transferred to the sheet P, the photosensitive drum 21 may or may not have the toner T remained on the surface thereof. The cleaning roller 26 removes the toner T remained on the surface of the photosensitive drum 21 after the transfer process. The cleaning roller 26 is disposed in such a manner as to contact a prescribed position on the surface of the photosensitive drum 21 and is rotated with rotation of the photosensitive drum 21. The photosensitive drum 21 is rotated about a rotation axis in a state that the cleaning roller 26 contacts the surface of the photosensitive drum 21, so that the cleaning roller 26 removes the toner T not transferred to the sheet P and remained on the surface of the photosensitive drum 21. Accordingly, the cleaned photosensitive drum 21 is repeatedly used.

A description is now given of the toner T according to the first embodiment. The toner T is a polymerized toner produced by polymerizing a colorant or an additive and a monomer while dispersing in aqueous medium. Particularly, the toner T is produced by a suspension polymerization method allowing a polymer particle to be formed in a toner size and spherical shape in a first step reaction.

According to the first embodiment, the toner T is, for example, made of resin including thermoplastic resin such as vinyl resin, polyamide resin, and polyester resin. Among such the thermoplastic resin, the vinyl resin includes the monomer, for example, made of: styrene or styrene derivative such as 2,4-dimethylstyrene, alpha-methyl styrene, p-ethylstyrene, o-methylstyrene, m-methylstyrene, p-methylstyrene, p-chlorostyrene, and vinylnaphthalene and the like; ethylenically monocarboxylic acid and ester thereof such as 2-ethylhexyl acrylate, methyl methacrylate, acrylic acid, methyl acrylate, ethyl acrylate, n-propyl acrylate, isobutyl acrylate, t-butyl acrylate, amyl acrylate, cyclohexyl acrylate, n-octyl acrylate, isooctyl acrylate, decyl acrylate, lauryl acrylate, stearyl acrylate, methoxyethyl acrylate, 2-hydroxyethyl acrylate, glycidyl acrylate, phenyl acrylate, methyl alpha-chloroacrylate, methacrylic acid, ethyl methacrylate, n-propyl methacrylate, isopropyl methacrylate, n-butyl methacrylate, isobutyl methacrylate, amyl methacrylate, cyclohexyl methacrylate, n-octyl methacrylate, isooctyl methacrylate, decyl methacrylate, lauryl methacrylate, 2-ethylhexyl methacrylate, stearyl methacrylate, methoxyethyl methacrylate, 2-hydroxyethyl methacrylate, glycidyl methacrylate, phenyl methacrylate, dimethylaminoethyl methacrylate, diethylaminoethyl methacrylate, and the like; ethylenically unsaturated monoolefin group such as ethylene, propylene, butylenes, isbutylene, and the like; a vinylester group such as vinyl chloride, vinyl bromoacetat, vinyl propionate, vinyl formate, vinyl caproate, and the like; ethylenically monocarboxylic acid substitution such as acrylonitrile, methacrylonitrile, acrylamide, and the like; ethylenically dicarboxylic acid such as maleic ester and the like and a substitution thereof, for example, a vinyl ketones group such as vinyl methyl ketone; or a vinyl ether group such as vinyl methyl ether and the like.

A cross-linking agent can be a general cross-linking agent, for example, made of: divinylbenzene, divinylnaphthalene, poly (ethylene glycol) dimethacrylate, 2,2-bis (4-methacryloxydiethoxydiphenyl) propane, 2,2-bis(4-acryloxydiethoxydiphenyl) propane, diethylene glycol diacrylate, triethylene glycol diacrylate, 1,3-butylene glycol dimethacrylate, 1,6-hexylene glycol dimethacrylate, neopentyl glycol dimethacrylate, dipropylene glycol dimethacrylate, polypropylene glycol dimethacrylate, trimethylopropane trimethacrylate, trimethylopropane triacrylate, tetramethylol methane tetreacrylate, or the like. Moreover, the cross-linking agent can be made of a combination of two or more such substances as may be needed.

The colorant can include a dye and a pigment used as a conventional black toner or a conventional colorant for a color toner. The colorant, for example, is made of: the carbon black, iron oxide, phthalocyanine blue, permanent brown FG, brilliant fast scarlet, pigment green B, rhodamine B, solvent red 49, solvent red 146, pigment blue 15:3, solvent blue 35, quinacridone, carmine 6B, disazo yellow, or the like.

An anti-offset agent can be made of a publicly known substance, for example: aliphatic hydrocarbon wax such as low-molecular-weight polyethylene, low-molecular-weight polypropylene, a copolymeric substance of olefin, microcrystalline wax, paraffin wax, fischer tropsch wax, and the like; oxide of aliphatic hydrocarbon wax such as a polyethylene wax oxide or a block copolymeric substance thereof; a wax group having aliphatic ester, as a main component, such as carnauba wax, ester wax montanate; or a substance, such as deoxidized carnauba wax, formed by partially or entirely deoxidizing the aliphatic ester.

The external additive is preferably made of inorganic fine powders to enhance environmental stability, charging stability, development property, flow property, and conservation property. The inorganic fine powders are, for example, made of: metal oxide such as zinc, aluminum, cerium, cobalt, iron, zirconium, chrome, manganese, strontium, tin, antimony, and the like; complex metal oxide such as calcium titanate, magnesium titanate, strontium titanate, and the like; metal salt such as barium sulfate, calcium carbonate, magnesium carbonate, aluminum carbonate, and the like; clay mineral such as kaoline and the like; a phosphate compound such as apatite and the like; a silicon compound such as silica, silicon carbide, silicon nitride, and the like; or carbon fine powers such as carbon black or graphite and the like.

Moreover, an additive can be added to the toner T as may be needed. The additive is, for example, a charge controlling agent, a conductive adjusting agent, an extender pigment, a reinforcement filler, for example, including a fibrous substance, an anti-oxidizing agent, an anti-aging agent, a flow improving agent, and the like.

### Example 1

The toner T having a non-magnetic property was produced by a method described below as a suspension polymerized toner according to the first embodiment of the present invention.

A polymerized composition was obtained by: adding 2 parts by weight of low-molecular-weight polystyrene, 1 part by weight of aizen spilon black TRH (available from Hodogaya Chemical Co., Ltd), 6 parts by weight of the carbon black (“PrintexL” available from Daicel-Evonik Ltd.), and 1 part by weight of 2,2′-azobisisobutyronitrile to 77.5 parts by weight of styrene and 22.5 parts by weight of n-butyl acrylate: inputting into an attritor (“MA-01SC” available from Nippon Coke & Engineering Co., Ltd.); and dispersing for 10 hours at a temperature of 15 degrees Celsius. Herein, the low-molecular-weight polystyrene served as the anti-offset agent, and the aizen spilon black TRH served as the charge controlling agent.

Separately, 180 parts by weight of ethanol was prepared by dissolving 8 parts by weight of polyacrylic acid and 0.35 parts by weight of divinylbenzene therein. Then, 600 parts by weight of distilled water was added to 180 parts by weight of the ethanol to prepare a dispersion medium for a polymerization reaction.

The polymerized composition was added to the dispersion medium and dispersed for 10 minutes under conditions of 15 degrees Celsius and 8000 rpm using a homogenizer (“Type M” available from Primix Corp.). Subsequently, the dispersion solution obtained was moved into a separable flask having a capacity of 1 little and was reacted for 12 hours at 85 degrees Celsius while being agitated under conditions of nitrogen atmosphere and 1000 rpm. A dispersed material obtained up to this point by polymerization reaction of the polymerized composition is referred to as an intermediate particle.

Next, a water emulsion AA was prepared by 9.25 parts by weight of methyl methacrylate, 0.75 parts by weight of n-butyl acrylate, 0.5 parts by weight of 2,2′-azobis(2-methylpropanenitrile), 0.1 parts by weight of sodium lauryl sulfate, and 80 parts by weight of distilled water. While an ultrasonic oscillator (“US-150” available from Nihonseiki Kaisha Ltd.) was oscillating water-based suspension having the intermediate particles therein, 9 parts by weight of the water emulsion AA was dropped, so that the intermediate particles were swollen. The intermediate particles were observed using an optical microscope immediately after 9 parts by weight of the water emulsion AA was dropped, and no water emulsion droplet was found based on the observation. Accordingly, the observation confirms that the swell of the intermediate particles is completed in a very short time.

A second-step polymerization of the water emulsion AA was performed for 6.0 hours at 85 degrees Celsius in the nitrogen atmosphere while the water emulsion AA was being agitated. That is, the water emulsion AA was reacted while being agitated. After completion of the reaction, the water emulsion AA was cooled down, and the dispersion medium was dissolved in 0.5 N hydrochloric acid solution. The dispersion medium was dried under the reduced pressure for 10 hours at 40 degrees Celsius with 10 mmHg after being filtered, washed with water, and dried with air. Then, the dispersion medium was classified using a wind classifier, and toner mother particles having a volume average particle size (also referred to as a volume average particle diameter) of 3.0 μm were obtained. Such toner mother particles are referred to as toner mother particles “A.”

The obtained toner (the toner mother particles) has the volume average particle size which can be measured by, for example, a measurement device connected with a personal computer and an interface (available from Nikkaki Bios Co. Ltd.) outputting a number distribution and a volume distribution using a “Coulter Counter TA-2” or “Coulter Multisizer 2” (both are available from Beckman Coulter, Inc.). For such a measurement, aqueous electrolyte solution is used. For example, 1% NaCl aqueous solution prepared using sodium chloride (first grade), or ISOTON R-II (available from Coulter Scientific Japan Co.) can be used as the aqueous electrolyte solution.

According to the method for measuring the volume average particle size, 0.1 ml to 5 ml of surfactant as disperse liquid was added to 100 ml to 150 ml of the aqueous electrolyte solution, and 2 mg to 20 mg of a measurement sample was further added. The aqueous electrolyte solution having the measurement sample suspended therein was dispersed for approximately 1 minute using an ultrasonic disperser. The “Coulter Counter TA-2” having an aperture of 100 μm was used to measure the volume of the toner having a size greater than or equal to 2 μm and calculate the volume distribution. The volume average particle size was determined based on the volume distribution calculated. A description of each of toner mother particles B, C, D, E, and G and the volume average particle size thereof are follows.

The second-step polymerization of the water emulsion AA was performed for 6.5 hours at 85 degrees Celsius, so that the toner mother particles serving as the toner mother particles “B” were obtained. The toner mother particles “B” had the volume average particle size of 3.5 μm.

The second-step polymerization of the water emulsion AA was performed for 7.0 hours at 85 degrees Celsius, so that the toner mother particles serving as the toner mother particles “C” were obtained. The toner mother particles “C” had the volume average particle size of 4.0 μm.

The second-step polymerization of the water emulsion AA was performed for 8.0 hours at 85 degrees Celsius, so that the toner mother particles serving as the toner mother particles “D” were obtained. The toner mother particles “D” had the volume average particle size of 5.0 μm.

The second-step polymerization of the water emulsion AA was performed for 9.0 hours at 85 degrees Celsius, so that the toner mother particles serving as the toner mother particles “E” were obtained. The toner mother particles “E” had the volume average particle size of 6.0 μm.

The second-step polymerization of the water emulsion AA was performed for 9.5 hours at 85 degrees Celsius, so that the toner mother particles serving as the toner mother particles “F” were obtained. The toner mother particles “F” had the volume average particle size of 6.5 μm.

The second-step polymerization of the water emulsion AA was performed for 10 hours at 85 degrees Celsius, so that the toner mother particles serving as the toner mother particles “G” were obtained. The toner mother particles “G” had the volume average particle size of 7.0 μm.

Subsequently, toners A-1 through G-20 serving as the toners T were produced by: adding 1.8 parts by weight of dry silica (“Aerosil RX50” available from Nippon Aerosil Co., Ltd.) serving as the external additive and a prescribed amount of the titanium oxide (“TTO-51(A)” available from Ishihara Sangyo Kaisha Ltd.) to 100 parts by weight of each of the toner mother particles “A,” the toner mother particles “B,” the toner mother particles “C,” the toner mother particles “D,” the toner mother particles “E,” the toner mother particles “F,” and the toner mother particles “G”; and mixing for 25 minutes. Herein, the titanium oxide had a particle size of any of 10 μm, 30 μm, 50 μm, 100 and 200 μm. The particle size is also referred to as a particle diameter.

### Example 1-1

The toner A-1 was obtained by adding 1.8 parts by weight of the Aerosil RX50 and 0.1 part by weight of the titanium oxide (10 μm) to 100 parts by weight of the toner mother particles “A” and mixing for 25 minutes.

### Example 1-2

The toner A-2 was obtained by adding 1.8 parts by weight of the Aerosil RX50 and 0.5 part by weight of the titanium oxide (10 μm) to 100 parts by weight of the toner mother particles “A” and mixing for 25 minutes.

### Example 1-3

The toner A-3 was obtained by adding 1.8 parts by weight of the Aerosil RX50 and 1.0 part by weight of the titanium oxide (10 μm) to 100 parts by weight of the toner mother particles “A” and mixing for 25 minutes.

### Example 1-4

The toner A-4 was obtained by adding 1.8 parts by weight of the Aerosil RX50 and 1.5 parts by weight of the titanium oxide (10 μm) to 100 parts by weight of the toner mother particles “A” and mixing for 25 minutes.

### Example 1-5

The toner A-5 was obtained by adding 1.8 parts by weight of the Aerosil RX50 and 0.1 part by weight of the titanium oxide (30 μm) to 100 parts by weight of the toner mother particles “A” and mixing for 25 minutes.

### Example 1-6

The toner A-6 was obtained by adding 1.8 parts by weight of the Aerosil RX50 and 0.5 part by weight of the titanium oxide (30 μm) to 100 parts by weight of the toner mother particles “A” and mixing for 25 minutes.

### Example 1-7

The toner A-7 was obtained by adding 1.8 parts by weight of the Aerosil RX50 and 1.0 part by weight of the titanium oxide (30 μm) to 100 parts by weight of the toner mother particles “A” and mixing for 25 minutes.

### Example 1-8

The toner A-8 was obtained by adding 1.8 parts by weight of the Aerosil RX50 and 1.5 parts by weight of the titanium oxide (30 μm) to 100 parts by weight of the toner mother particles “A” and mixing for 25 minutes.

### Example 1-9

The toner A-9 was obtained by adding 1.8 parts by weight of the Aerosil RX50 and 0.1 part by weight of the titanium oxide (50 μm) to 100 parts by weight of the toner mother particles “A” and mixing for 25 minutes.

### Example 1-10

The toner A-10 was obtained by adding 1.8 parts by weight of the Aerosil RX50 and 0.5 part by weight of the titanium oxide (50 μm) to 100 parts by weight of the toner mother particles “A” and mixing for 25 minutes.

### Example 1-11

The toner A-11 was obtained by adding 1.8 parts by weight of the Aerosil RX50 and 1.0 part by weight of the titanium oxide (50 μm) to 100 parts by weight of the toner mother particles “A” and mixing for 25 minutes.

### Example 1-12

The toner A-12 was obtained by adding 1.8 parts by weight of the Aerosil RX50 and 1.5 parts by weight of the titanium oxide (50 μm) to 100 parts by weight of the toner mother particles “A” and mixing for 25 minutes.

### Example 1-13

The toner A-13 was obtained by adding 1.8 parts by weight of the Aerosil RX50 and 0.1 part by weight of the titanium oxide (100 μn) to 100 parts by weight of the toner mother particles “A” and mixing for 25 minutes.

### Example 1-14

The toner A-14 was obtained by adding 1.8 parts by weight of the Aerosil RX50 and 0.5 part by weight of the titanium oxide (100 μm) to 100 parts by weight of the toner mother particles “A” and mixing for 25 minutes.

### Example 1-15

The toner A-15 was obtained by adding 1.8 parts by weight of the Aerosil RX50 and 1.0 part by weight of the titanium oxide (100 μm) to 100 parts by weight of the toner mother particles “A” and mixing for 25 minutes.

### Example 1-16

The toner A-16 was obtained by adding 1.8 parts by weight of the Aerosil RX50 and 1.5 parts by weight of the titanium oxide (100 μm) to 100 parts by weight of the toner mother particles “A” and mixing for 25 minutes.

### Example 1-17

The toner B-1 was obtained by adding 1.8 parts by weight of the Aerosil RX50 and 0.1 part by weight of the titanium oxide (10 μm) to 100 parts by weight of the toner mother particles “B” and mixing for 25 minutes.

### Example 1-18

The toner B-2 was obtained by adding 1.8 parts by weight of the Aerosil RX50 and 0.5 part by weight of the titanium oxide (10 μm) to 100 parts by weight of the toner mother particles “B” and mixing for 25 minutes.

### Example 1-19

The toner B-3 was obtained by adding 1.8 parts by weight of the Aerosil RX50 and 1.0 part by weight of the titanium oxide (10 μm) to 100 parts by weight of the toner mother particles “B” and mixing for 25 minutes.

### Example 1-20

The toner B-4 was obtained by adding 1.8 parts by weight of the Aerosil RX50 and 1.5 parts by weight of the titanium oxide (10 μm) to 100 parts by weight of the toner mother particles “B” and mixing for 25 minutes.

### Example 1-21

The toner B-5 was obtained by adding 1.8 parts by weight of the Aerosil RX50 and 0.1 part by weight of the titanium oxide (30 μm) to 100 parts by weight of the toner mother particles “B” and mixing for 25 minutes.

### Example 1-22

The toner B-6 was obtained by adding 1.8 parts by weight of the Aerosil RX50 and 0.5 part by weight of the titanium oxide (30 μm) to 100 parts by weight of the toner mother particles “B” and mixing for 25 minutes.

### Example 1-23

The toner B-7 was obtained by adding 1.8 parts by weight of the Aerosil RX50 and 1.0 part by weight of the titanium oxide (30 μm) to 100 parts by weight of the toner mother particles “B” and mixing for 25 minutes.

### Example 1-24

The toner B-8 was obtained by adding 1.8 parts by weight of the Aerosil RX50 and 1.5 parts by weight of the titanium oxide (30 μm) to 100 parts by weight of the toner mother particles “B” and mixing for 25 minutes.

### Example 1-25

The toner B-9 was obtained by adding 1.8 parts by weight of the Aerosil RX50 and 0.1 part by weight of the titanium oxide (50 μm) to 100 parts by weight of the toner mother particles “B” and mixing for 25 minutes.

### Example 1-26

The toner B-10 was obtained by adding 1.8 parts by weight of the Aerosil RX50 and 0.5 part by weight of the titanium oxide (50 μm) to 100 parts by weight of the toner mother particles “B” and mixing for 25 minutes.

### Example 1-27

The toner B-11 was obtained by adding 1.8 parts by weight of the Aerosil RX50 and 1.0 part by weight of the titanium oxide (50 μm) to 100 parts by weight of the toner mother particles “B” and mixing for 25 minutes.

### Example 1-28

The toner B-12 was obtained by adding 1.8 parts by weight of the Aerosil RX50 and 1.5 parts by weight of the titanium oxide (50 μm) to 100 parts by weight of the toner mother particles “B” and mixing for 25 minutes.

### Example 1-29

The toner B-13 was obtained by adding 1.8 parts by weight of the Aerosil RX50 and 0.1 part by weight of the titanium oxide (100 μm) to 100 parts by weight of the toner mother particles “B” and mixing for 25 minutes.

### Example 1-30

The toner B-14 was obtained by adding 1.8 parts by weight of the Aerosil RX50 and 0.5 part by weight of the titanium oxide (100 μm) to 100 parts by weight of the toner mother particles “B” and mixing for 25 minutes.

### Example 1-31

The toner B-15 was obtained by adding 1.8 parts by weight of the Aerosil RX50 and 1.0 part by weight of the titanium oxide (100 μn) to 100 parts by weight of the toner mother particles “B” and mixing for 25 minutes.

### Example 1-32

The toner B-16 was obtained by adding 1.8 parts by weight of the Aerosil RX50 and 1.5 parts by weight of the titanium oxide (100 μm) to 100 parts by weight of the toner mother particles “B” and mixing for 25 minutes.

### Example 1-33

The toner C-1 was obtained by adding 1.8 parts by weight of the Aerosil RX50 and 0.1 part by weight of the titanium oxide (10 μm) to 100 parts by weight of the toner mother particles “C” and mixing for 25 minutes.

### Example 1-34

The toner C-2 was obtained by adding 1.8 parts by weight of the Aerosil RX50 and 0.5 part by weight of the titanium oxide (10 μm) to 100 parts by weight of the toner mother particles “C” and mixing for 25 minutes.

### Example 1-35

The toner C-3 was obtained by adding 1.8 parts by weight of the Aerosil RX50 and 1.0 part by weight of the titanium oxide (10 μm) to 100 parts by weight of the toner mother particles “C” and mixing for 25 minutes.

### Example 1-36

The toner C-4 was obtained by adding 1.8 parts by weight of the Aerosil RX50 and 1.5 parts by weight of the titanium oxide (10 μm) to 100 parts by weight of the toner mother particles “C” and mixing for 25 minutes.

### Example 1-37

The toner C-5 was obtained by adding 1.8 parts by weight of the Aerosil RX50 and 0.1 part by weight of the titanium oxide (30 μm) to 100 parts by weight of the toner mother particles “C” and mixing for 25 minutes.

### Example 1-38

The toner C-6 was obtained by adding 1.8 parts by weight of the Aerosil RX50 and 0.5 part by weight of the titanium oxide (30 μm) to 100 parts by weight of the toner mother particles “C” and mixing for 25 minutes.

### Example 1-39

The toner C-7 was obtained by adding 1.8 parts by weight of the Aerosil RX50 and 1.0 part by weight of the titanium oxide (30 μm) to 100 parts by weight of the toner mother particles “C” and mixing for 25 minutes.

### Example 1-40

The toner C-8 was obtained by adding 1.8 parts by weight of the Aerosil RX50 and 1.5 parts by weight of the titanium oxide (30 μm) to 100 parts by weight of the toner mother particles “C” and mixing for 25 minutes.

### Example 1-41

The toner C-9 was obtained by adding 1.8 parts by weight of the Aerosil RX50 and 0.1 part by weight of the titanium oxide (50 μm) to 100 parts by weight of the toner mother particles “C” and mixing for 25 minutes.

### Example 1-42

The toner C-10 was obtained by adding 1.8 parts by weight of the Aerosil RX50 and 0.5 part by weight of the titanium oxide (50 μm) to 100 parts by weight of the toner mother particles “C” and mixing for 25 minutes.

### Example 1-43

The toner C-11 was obtained by adding 1.8 parts by weight of the Aerosil RX50 and 1.0 part by weight of the titanium oxide (50 μm) to 100 parts by weight of the toner mother particles “C” and mixing for 25 minutes.

### Example 1-44

The toner C-12 was obtained by adding 1.8 parts by weight of the Aerosil RX50 and 1.5 parts by weight of the titanium oxide (50 μm) to 100 parts by weight of the toner mother particles “C” and mixing for 25 minutes.

### Example 1-45

The toner C-13 was obtained by adding 1.8 parts by weight of the Aerosil RX50 and 0.1 part by weight of the titanium oxide (100 μm) to 100 parts by weight of the toner mother particles “C” and mixing for 25 minutes.

### Example 1-46

The toner C-14 was obtained by adding 1.8 parts by weight of the Aerosil RX50 and 0.5 part by weight of the titanium oxide (100 μm) to 100 parts by weight of the toner mother particles “C” and mixing for 25 minutes.

### Example 1-47

The toner C-15 was obtained by adding 1.8 parts by weight of the Aerosil RX50 and 1.0 part by weight of the titanium oxide (100 μm) to 100 parts by weight of the toner mother particles “C” and mixing for 25 minutes.

### Example 1-48

The toner C-16 was obtained by adding 1.8 parts by weight of the Aerosil RX50 and 1.5 parts by weight of the titanium oxide (100 μm) to 100 parts by weight of the toner mother particles “C” and mixing for 25 minutes.

### Example 1-49

The toner D-1 was obtained by adding 1.8 parts by weight of the Aerosil RX50 and 0.1 part by weight of the titanium oxide (10 μm) to 100 parts by weight of the toner mother particles “D” and mixing for 25 minutes.

### Example 1-50

The toner D-2 was obtained by adding 1.8 parts by weight of the Aerosil RX50 and 0.5 part by weight of the titanium oxide (10 μm) to 100 parts by weight of the toner mother particles “D” and mixing for 25 minutes.

### Example 1-51

The toner D-3 was obtained by adding 1.8 parts by weight of the Aerosil RX50 and 1.0 part by weight of the titanium oxide (10 μm) to 100 parts by weight of the toner mother particles “D” and mixing for 25 minutes.

### Example 1-52

The toner D-4 was obtained by adding 1.8 parts by weight of the Aerosil RX50 and 1.5 parts by weight of the titanium oxide (10 μm) to 100 parts by weight of the toner mother particles “D” and mixing for 25 minutes.

### Example 1-53

The toner D-5 was obtained by adding 1.8 parts by weight of the Aerosil RX50 and 0.1 part by weight of the titanium oxide (30 μm) to 100 parts by weight of the toner mother particles “D” and mixing for 25 minutes.

### Example 1-54

The toner D-6 was obtained by adding 1.8 parts by weight of the Aerosil RX50 and 0.5 part by weight of the titanium oxide (30 μm) to 100 parts by weight of the toner mother particles “D” and mixing for 25 minutes.

### Example 1-55

The toner D-7 was obtained by adding 1.8 parts by weight of the Aerosil RX50 and 1.0 part by weight of the titanium oxide (30 μm) to 100 parts by weight of the toner mother particles “D” and mixing for 25 minutes.

### Example 1-56

The toner D-8 was obtained by adding 1.8 parts by weight of the Aerosil RX50 and 1.5 parts by weight of the titanium oxide (30 μm) to 100 parts by weight of the toner mother particles “D” and mixing for 25 minutes.

### Example 1-57

The toner D-9 was obtained by adding 1.8 parts by weight of the Aerosil RX50 and 0.1 part by weight of the titanium oxide (50 μm) to 100 parts by weight of the toner mother particles “D” and mixing for 25 minutes.

### Example 1-58

The toner D-10 was obtained by adding 1.8 parts by weight of the Aerosil RX50 and 0.5 part by weight of the titanium oxide (50 μm) to 100 parts by weight of the toner mother particles “D” and mixing for 25 minutes.

### Example 1-59

The toner D-11 was obtained by adding 1.8 parts by weight of the Aerosil RX50 and 1.0 part by weight of the titanium oxide (50 μm) to 100 parts by weight of the toner mother particles “D” and mixing for 25 minutes.

### Example 1-60

The toner D-12 was obtained by adding 1.8 parts by weight of the Aerosil RX50 and 1.5 parts by weight of the titanium oxide (50 μm) to 100 parts by weight of the toner mother particles “D” and mixing for 25 minutes.

### Example 1-61

The toner D-13 was obtained by adding 1.8 parts by weight of the Aerosil RX50 and 0.1 part by weight of the titanium oxide (100 μm) to 100 parts by weight of the toner mother particles “D” and mixing for 25 minutes.

### Example 1-62

The toner D-14 was obtained by adding 1.8 parts by weight of the Aerosil RX50 and 0.5 part by weight of the titanium oxide (100 μm) to 100 parts by weight of the toner mother particles “D” and mixing for 25 minutes.

### Example 1-63

The toner D-15 was obtained by adding 1.8 parts by weight of the Aerosil RX50 and 1.0 part by weight of the titanium oxide (100 μm) to 100 parts by weight of the toner mother particles “D” and mixing for 25 minutes.

### Example 1-64

The toner D-16 was obtained by adding 1.8 parts by weight of the Aerosil RX50 and 1.5 parts by weight of the titanium oxide (100 μm) to 100 parts by weight of the toner mother particles “D” and mixing for 25 minutes.

### Example 1-65

The toner E-1 was obtained by adding 1.8 parts by weight of the Aerosil RX50 and 0.1 part by weight of the titanium oxide (10 μm) to 100 parts by weight of the toner mother particles “E” and mixing for 25 minutes.

### Example 1-66

The toner E-2 was obtained by adding 1.8 parts by weight of the Aerosil RX50 and 0.5 part by weight of the titanium oxide (10 μm) to 100 parts by weight of the toner mother particles “E” and mixing for 25 minutes.

### Example 1-67

The toner E-3 was obtained by adding 1.8 parts by weight of the Aerosil RX50 and 1.0 part by weight of the titanium oxide (10 μm) to 100 parts by weight of the toner mother particles “E” and mixing for 25 minutes.

### Example 1-68

The toner E-4 was obtained by adding 1.8 parts by weight of the Aerosil RX50 and 1.5 parts by weight of the titanium oxide (10 μm) to 100 parts by weight of the toner mother particles “E” and mixing for 25 minutes.

### Example 1-69

The toner E-5 was obtained by adding 1.8 parts by weight of the Aerosil RX50 and 0.1 part by weight of the titanium oxide (30 μm) to 100 parts by weight of the toner mother particles “E” and mixing for 25 minutes.

### Example 1-70

The toner E-6 was obtained by adding 1.8 parts by weight of the Aerosil RX50 and 0.5 part by weight of the titanium oxide (30 μm) to 100 parts by weight of the toner mother particles “E” and mixing for 25 minutes.

### Example 1-71

The toner E-7 was obtained by adding 1.8 parts by weight of the Aerosil RX50 and 1.0 part by weight of the titanium oxide (30 μm) to 100 parts by weight of the toner mother particles “E” and mixing for 25 minutes.

### Example 1-72

The toner E-8 was obtained by adding 1.8 parts by weight of the Aerosil RX50 and 1.5 parts by weight of the titanium oxide (30 μm) to 100 parts by weight of the toner mother particles “E” and mixing for 25 minutes.

### Example 1-73

The toner E-9 was obtained by adding 1.8 parts by weight of the Aerosil RX50 and 0.1 part by weight of the titanium oxide (50 μm) to 100 parts by weight of the toner mother particles “E” and mixing for 25 minutes.

### Example 1-74

The toner E-10 was obtained by adding 1.8 parts by weight of the Aerosil RX50 and 0.5 part by weight of the titanium oxide (50 μm) to 100 parts by weight of the toner mother particles “E” and mixing for 25 minutes.

### Example 1-75

The toner E-11 was obtained by adding 1.8 parts by weight of the Aerosil RX50 and 1.0 part by weight of the titanium oxide (50 μm) to 100 parts by weight of the toner mother particles “E” and mixing for 25 minutes.

### Example 1-76

The toner E-12 was obtained by adding 1.8 parts by weight of the Aerosil RX50 and 1.5 parts by weight of the titanium oxide (50 μm) to 100 parts by weight of the toner mother particles “E” and mixing for 25 minutes.

### Example 1-77

The toner E-13 was obtained by adding 1.8 parts by weight of the Aerosil RX50 and 0.1 part by weight of the titanium oxide (100 μm) to 100 parts by weight of the toner mother particles “E” and mixing for 25 minutes.

### Example 1-78

The toner E-14 was obtained by adding 1.8 parts by weight of the Aerosil RX50 and 0.5 part by weight of the titanium oxide (100 μm) to 100 parts by weight of the toner mother particles “E” and mixing for 25 minutes.

### Example 1-79

The toner E-15 was obtained by adding 1.8 parts by weight of the Aerosil RX50 and 1.0 part by weight of the titanium oxide (100 μm) to 100 parts by weight of the toner mother particles “E” and mixing for 25 minutes.

### Example 1-80

The toner E-16 was obtained by adding 1.8 parts by weight of the Aerosil RX50 and 1.5 parts by weight of the titanium oxide (100 μm) to 100 parts by weight of the toner mother particles “E” and mixing for 25 minutes.

### Example 1-81

The toner F-1 was obtained by adding 1.8 parts by weight of the Aerosil RX50 and 0.1 part by weight of the titanium oxide (10 μm) to 100 parts by weight of the toner mother particles “F” and mixing for 25 minutes.

### Example 1-82

The toner F-2 was obtained by adding 1.8 parts by weight of the Aerosil RX50 and 0.5 part by weight of the titanium oxide (10 μm) to 100 parts by weight of the toner mother particles “F” and mixing for 25 minutes.

### Example 1-83

The toner F-3 was obtained by adding 1.8 parts by weight of the Aerosil RX50 and 1.0 part by weight of the titanium oxide (10 μm) to 100 parts by weight of the toner mother particles “F” and mixing for 25 minutes.

### Example 1-84

The toner F-4 was obtained by adding 1.8 parts by weight of the Aerosil RX50 and 1.5 parts by weight of the titanium oxide (10 μm) to 100 parts by weight of the toner mother particles “F” and mixing for 25 minutes.

### Example 1-85

The toner F-5 was obtained by adding 1.8 parts by weight of the Aerosil RX50 and 0.1 part by weight of the titanium oxide (30 μm) to 100 parts by weight of the toner mother particles “F” and mixing for 25 minutes.

### Example 1-86

The toner F-6 was obtained by adding 1.8 parts by weight of the Aerosil RX50 and 0.5 part by weight of the titanium oxide (30 μm) to 100 parts by weight of the toner mother particles “F” and mixing for 25 minutes.

### Example 1-87

The toner F-7 was obtained by adding 1.8 parts by weight of the Aerosil RX50 and 1.0 part by weight of the titanium oxide (30 μm) to 100 parts by weight of the toner mother particles “F” and mixing for 25 minutes.

### Example 1-88

The toner F-8 was obtained by adding 1.8 parts by weight of the Aerosil RX50 and 1.5 parts by weight of the titanium oxide (30 μm) to 100 parts by weight of the toner mother particles “F” and mixing for 25 minutes.

### Example 1-89

The toner F-9 was obtained by adding 1.8 parts by weight of the Aerosil RX50 and 0.1 part by weight of the titanium oxide (50 μm) to 100 parts by weight of the toner mother particles “F” and mixing for 25 minutes.

### Example 1-90

The toner F-10 was obtained by adding 1.8 parts by weight of the Aerosil RX50 and 0.5 part by weight of the titanium oxide (50 μm) to 100 parts by weight of the toner mother particles “F” and mixing for 25 minutes.

### Example 1-91

The toner F-11 was obtained by adding 1.8 parts by weight of the Aerosil RX50 and 1.0 part by weight of the titanium oxide (50 μm) to 100 parts by weight of the toner mother particles “F” and mixing for 25 minutes.

### Example 1-92

The toner F-13 was obtained by adding 1.8 parts by weight of the Aerosil RX50 and 0.1 part by weight of the titanium oxide (100 μm) to 100 parts by weight of the toner mother particles “F” and mixing for 25 minutes.

### Example 1-93

The toner F-14 was obtained by adding 1.8 parts by weight of the Aerosil RX50 and 0.5 part by weight of the titanium oxide (100 μm) to 100 parts by weight of the toner mother particles “F” and mixing for 25 minutes.

### Example 1-94

The toner F-15 was obtained by adding 1.8 parts by weight of the Aerosil RX50 and 1.0 part by weight of the titanium oxide (100 μm) to 100 parts by weight of the toner mother particles “F” and mixing for 25 minutes.

### Example 1-95

The toner G-1 was obtained by adding 1.8 parts by weight of the Aerosil RX50 and 0.1 part by weight of the titanium oxide (10 μm) to 100 parts by weight of the toner mother particles “G” and mixing for 25 minutes.

### Example 1-96

The toner G-2 was obtained by adding 1.8 parts by weight of the Aerosil RX50 and 0.5 part by weight of the titanium oxide (10 μm) to 100 parts by weight of the toner mother particles “G” and mixing for 25 minutes.

### Example 1-97

The toner G-3 was obtained by adding 1.8 parts by weight of the Aerosil RX50 and 1.0 part by weight of the titanium oxide (10 μm) to 100 parts by weight of the toner mother particles “G” and mixing for 25 minutes.

### Example 1-98

The toner G-4 was obtained by adding 1.8 parts by weight of the Aerosil RX50 and 1.5 parts by weight of the titanium oxide (10 μm) to 100 parts by weight of the toner mother particles “G” and mixing for 25 minutes.

### Example 1-99

The toner G-5 was obtained by adding 1.8 parts by weight of the Aerosil RX50 and 0.1 part by weight of the titanium oxide (30 μm) to 100 parts by weight of the toner mother particles “G” and mixing for 25 minutes.

### Example 1-100

The toner G-6 was obtained by adding 1.8 parts by weight of the Aerosil RX50 and 0.5 part by weight of the titanium oxide (30 μm) to 100 parts by weight of the toner mother particles “G” and mixing for 25 minutes.

### Example 1-101

The toner G-7 was obtained by adding 1.8 parts by weight of the Aerosil RX50 and 1.0 part by weight of the titanium oxide (30 μm) to 100 parts by weight of the toner mother particles “G” and mixing for 25 minutes.

### Example 1-102

The toner G-8 was obtained by adding 1.8 parts by weight of the Aerosil RX50 and 1.5 parts by weight of the titanium oxide (30 μm) to 100 parts by weight of the toner mother particles “G” and mixing for 25 minutes.

### Example 1-103

The toner G-9 was obtained by adding 1.8 parts by weight of the Aerosil RX50 and 0.1 part by weight of the titanium oxide (50 μm) to 100 parts by weight of the toner mother particles “G” and mixing for 25 minutes.

### Example 1-104

The toner G-10 was obtained by adding 1.8 parts by weight of the Aerosil RX50 and 0.5 part by weight of the titanium oxide (50 μm) to 100 parts by weight of the toner mother particles “G” and mixing for 25 minutes.

### Example 1-105

The toner G-11 was obtained by adding 1.8 parts by weight of the Aerosil RX50 and 1.0 part by weight of the titanium oxide (50 μm) to 100 parts by weight of the toner mother particles “G” and mixing for 25 minutes.

### Example 1-106

The toner G-13 was obtained by adding 1.8 parts by weight of the Aerosil RX50 and 0.1 part by weight of the titanium oxide (100 μm) to 100 parts by weight of the toner mother particles “G” and mixing for 25 minutes.

### Example 1-107

The toner G-14 was obtained by adding 1.8 parts by weight of the Aerosil RX50 and 0.5 part by weight of the titanium oxide (100 μm) to 100 parts by weight of the toner mother particles “G” and mixing for 25 minutes.

### Example 1-108

The toner G-15 was obtained by adding 1.8 parts by weight of the Aerosil RX50 and 1.0 part by weight of the titanium oxide (100 μm) to 100 parts by weight of the toner mother particles “G” and mixing for 25 minutes.

### Comparison Example 1-1

The toner A-17 was obtained by adding 1.8 parts by weight of the Aerosil RX50 and 0.1 part by weight of the titanium oxide (200 μm) to 100 parts by weight of the toner mother particles “A” and mixing for 25 minutes.

### Comparison Example 1-2

The toner A-18 was obtained by adding 1.8 parts by weight of the Aerosil RX50 and 0.5 part by weight of the titanium oxide (200 μm) to 100 parts by weight of the toner mother particles “A” and mixing for 25 minutes.

### Comparison Example 1-3

The toner A-19 was obtained by adding 1.8 parts by weight of the Aerosil RX50 and 1.0 part by weight of the titanium oxide (200 μm) to 100 parts by weight of the toner mother particles “A” and mixing for 25 minutes.

### Comparison Example 1-4

The toner A-20 was obtained by adding 1.8 parts by weight of the Aerosil RX50 and 1.5 parts by weight of the titanium oxide (200 μm) to 100 parts by weight of the toner mother particles “A” and mixing for 25 minutes.

### Comparison Example 1-5

The toner B-17 was obtained by adding 1.8 parts by weight of the Aerosil RX50 and 0.1 part by weight of the titanium oxide (200 μm) to 100 parts by weight of the toner mother particles “B” and mixing for 25 minutes.

### Comparison Example 1-6

The toner B-18 was obtained by adding 1.8 parts by weight of the Aerosil RX50 and 0.5 part by weight of the titanium oxide (200 μm) to 100 parts by weight of the toner mother particles “B” and mixing for 25 minutes.

### Comparison Example 1-7

The toner B-19 was obtained by adding 1.8 parts by weight of the Aerosil RX50 and 1.0 part by weight of the titanium oxide (200 μm) to 100 parts by weight of the toner mother particles “B” and mixing for 25 minutes.

### Comparison Example 1-8

The toner B-20 was obtained by adding 1.8 parts by weight of the Aerosil RX50 and 1.5 parts by weight of the titanium oxide (200 μm) to 100 parts by weight of the toner mother particles “B” and mixing for 25 minutes.

### Comparison Example 1-9

The toner C-17 was obtained by adding 1.8 parts by weight of the Aerosil RX50 and 0.1 part by weight of the titanium oxide (200 μm) to 100 parts by weight of the toner mother particles “C” and mixing for 25 minutes.

### Comparison Example 1-10

The toner C-18 was obtained by adding 1.8 parts by weight of the Aerosil RX50 and 0.5 part by weight of the titanium oxide (200 μm) to 100 parts by weight of the toner mother particles “C” and mixing for 25 minutes.

### Comparison Example 1-11

The toner C-19 was obtained by adding 1.8 parts by weight of the Aerosil RX50 and 1.0 part by weight of the titanium oxide (200 μm) to 100 parts by weight of the toner mother particles “C” and mixing for 25 minutes.

### Comparison Example 1-12

The toner C-20 was obtained by adding 1.8 parts by weight of the Aerosil RX50 and 1.5 parts by weight of the titanium oxide (200 μm) to 100 parts by weight of the toner mother particles “C” and mixing for 25 minutes.

### Comparison Example 1-13

The toner D-17 was obtained by adding 1.8 parts by weight of the Aerosil RX50 and 0.1 part by weight of the titanium oxide (200 μm) to 100 parts by weight of the toner mother particles “D” and mixing for 25 minutes.

### Comparison Example 1-14

The toner D-18 was obtained by adding 1.8 parts by weight of the Aerosil RX50 and 0.5 part by weight of the titanium oxide (200 μm) to 100 parts by weight of the toner mother particles “D” and mixing for 25 minutes.

### Comparison Example 1-15

The toner D-19 was obtained by adding 1.8 parts by weight of the Aerosil RX50 and 1.0 part by weight of the titanium oxide (200 μm) to 100 parts by weight of the toner mother particles “D” and mixing for 25 minutes.

### Comparison Example 1-16

The toner D-20 was obtained by adding 1.8 parts by weight of the Aerosil RX50 and 1.5 parts by weight of the titanium oxide (200 μm) to 100 parts by weight of the toner mother particles “D” and mixing for 25 minutes.

### Comparison Example 1-17

The toner E-17 was obtained by adding 1.8 parts by weight of the Aerosil RX50 and 0.1 part by weight of the titanium oxide (200 μm) to 100 parts by weight of the toner mother particles “E” and mixing for 25 minutes.

### Comparison Example 1-18

The toner E-18 was obtained by adding 1.8 parts by weight of the Aerosil RX50 and 0.5 part by weight of the titanium oxide (200 μm) to 100 parts by weight of the toner mother particles “E” and mixing for 25 minutes.

### Comparison Example 1-19

The toner E-19 was obtained by adding 1.8 parts by weight of the Aerosil RX50 and 1.0 part by weight of the titanium oxide (200 μm) to 100 parts by weight of the toner mother particles “E” and mixing for 25 minutes.

### Comparison Example 1-20

The toner E-20 was obtained by adding 1.8 parts by weight of the Aerosil RX50 and 1.5 parts by weight of the titanium oxide (200 μm) to 100 parts by weight of the toner mother particles “E” and mixing for 25 minutes.

### Comparison Example 1-21

The toner F-12 was obtained by adding 1.8 parts by weight of the Aerosil RX50 and 1.5 parts by weight of the titanium oxide (50 μm) to 100 parts by weight of the toner mother particles “F” and mixing for 25 minutes.

### Comparison Example 1-22

The toner F-16 was obtained by adding 1.8 parts by weight of the Aerosil RX50 and 1.5 parts by weight of the titanium oxide (100 μm) to 100 parts by weight of the toner mother particles “F” and mixing for 25 minutes.

### Comparison Example 1-23

The toner F-17 was obtained by adding 1.8 parts by weight of the Aerosil RX50 and 0.1 part by weight of the titanium oxide (200 μm) to 100 parts by weight of the toner mother particles “F” and mixing for 25 minutes.

### Comparison Example 1-24

The toner F-18 was obtained by adding 1.8 parts by weight of the Aerosil RX50 and 0.5 part by weight of the titanium oxide (200 μm) to 100 parts by weight of the toner mother particles “F” and mixing for 25 minutes.

### Comparison Example 1-25

The toner F-19 was obtained by adding 1.8 parts by weight of the Aerosil RX50 and 1.0 part by weight of the titanium oxide (200 μm) to 100 parts by weight of the toner mother particles “F” and mixing for 25 minutes.

### Comparison Example 1-26

The toner F-20 was obtained by adding 1.8 parts by weight of the Aerosil RX50 and 1.5 parts by weight of the titanium oxide (200 μm) to 100 parts by weight of the toner mother particles “F” and mixing for 25 minutes.

### Comparison Example 1-27

The toner G-12 was obtained by adding 1.8 parts by weight of the Aerosil RX50 and 1.5 parts by weight of the titanium oxide (50 μm) to 100 parts by weight of the toner mother particles “G” and mixing for 25 minutes.

### Comparison Example 1-28

The toner G-16 was obtained by adding 1.8 parts by weight of the Aerosil RX50 and 1.5 parts by weight of the titanium oxide (100 μm) to 100 parts by weight of the toner mother particles “G” and mixing for 25 minutes.

### Comparison Example 1-29

The toner G-17 was obtained by adding 1.8 parts by weight of the Aerosil RX50 and 0.1 part by weight of the titanium oxide (200 μm) to 100 parts by weight of the toner mother particles “G” and mixing for 25 minutes.

### Comparison Example 1-30

The toner G-18 was obtained by adding 1.8 parts by weight of the Aerosil RX50 and 0.5 part by weight of the titanium oxide (200 μm) to 100 parts by weight of the toner mother particles “G” and mixing for 25 minutes.

### Comparison Example 1-31

The toner G-19 was obtained by adding 1.8 parts by weight of the Aerosil RX50 and 1.0 part by weight of the titanium oxide (200 μm) to 100 parts by weight of the toner mother particles “G” and mixing for 25 minutes.

### Comparison Example 1-32

The toner G-20 was obtained by adding 1.8 parts by weight of the Aerosil RX50 and 1.5 parts by weight of the titanium oxide (200 μm) to 100 parts by weight of the toner mother particles “G” and mixing for 25 minutes.

After the toner A-1 through the toner G-20 were produced, a degree of sphericity thereof was measured and calculated by a following method. First, 4 to 6 droplets of neutral detergent were dropped into a beaker having a capacity of 100 ml. Second, 100 ml of the aqueous electrolyte solution was added in the beaker (that is, the neutral detergent was approximately 0.5% relative to the aqueous electrolyte solution in the beaker) and was slightly oscillated, so that the disperse liquid was dissolved. Third, the toner T was added in the beaker using a micro-spatula in an amount of a heaping micro-spatula. Fourth, an ultrasonic treatment was performed to the beaker as a whole for 60 seconds in an ultrasonic cleaner, so that the toner T was dispersed. Fifth, each of lengths L1, L2 (described later) was measured using a flow type particle image analyzer (“FPIA-2000” available from Sysmex Corp.). Finally, the degree of sphericity was calculated based on a formula (stated below). Herein, the degree of sphericity for each of the toners A-1 through G-20 was determined based on an average value of plural particles. According to the first embodiment, the toner T produced by the suspension polymerization method had the degree of sphericity of greater than or equal to 0.97.

Degree of sphericity=L1/L2

L1: a circumference length of a circle having an area substantially the same as an area of a particle projection image.

L2: a circumference length of the particle projection image.

Where a value for the degree of sphericity is 1, the particle is determined to be sphere. The smaller the value for the degree of sphericity, the greater the irregularity in particle shape.

Next, the toners A-1 through G-20 were applied to the printer 100, and drum fog was examined as follows.

The development roller 23 of the development device 20 was set to have a circumferential speed of 189.2 mm/s. An A4-sized standard sheet (e.g., OKI excellent white sheet having a basis weight of 80 g/m²) was fed in a longitudinal direction (i.e., two short sides among four sides were respectively fed in a leading end and a tailing end), and a 100% Duty image, a 50% Duty image, and a 0% Duty image were printed on the respective sheets (i.e., total of three sheets) by the printer 100. Then, the printer 100 was switched off. Herein, the 100 Duty image represents an image having a print area ratio of 100% in a printable area across the A4-sized sheet. The 100% Duty image, 50% Duty image, and 0% Duty image are hereafter referred to as a solid black image, a half-tone image, and a blank sheet, respectively.

Subsequently, the development device 20 was detached from the printer 100 and left for one week under environmental conditions of normal temperature (24 degrees Celsius) and humidity of 40%. After the one week, the development device 20 was attached to the printer 100, so that the printer 100 was allowed to reprint the blank sheet (i.e., one blank sheet was printed again). The printer 100 was switched off to instantaneously interrupt the power supplied thereto in the course of the printing the blank sheet.

The development device 20 was detached from the printer 100, and a transparent mending tape was adhered to the photosensitive drum 21 to peel the toner attached to the photosensitive drum 21. The mending tape was removed from the photosensitive drum 21 and was adhered to a white sheet on which a mending tape was adhered beforehand. Thereafter, the drum fog was evaluated by measuring a color difference ΔE using a spectro-photometer (“CM-2600d,” a measurement diameter of Φ8 mm, available from Konika Minolta Sensing Inc.). The color difference ΔE represents the color difference between the mending tape on the white sheet and the mending tape peeled from the photosensitive drum 21.

A color difference ΔE={(L₁−L₂)²+(a₁−a₂)²+(b₁−b₂)²}^{1/2}, where each of L₁, a₁, and b₁ represents chromaticity of the mending tape peeled from the photosensitive drum 21 instantaneously interrupted in the course of printing the blank sheet, and each of L₂, a₂, and b₂ represents an average value of chromaticity of the mending tape. Herein, the average value was determined based on measurements of the chromaticity in five (5) similar positions.

Accordingly, the drum fog was evaluated based on the measurement of the blank sheet printed by the printer 100 after the development device 20 was left for one week. The drum fog was evaluated according to the follow ratings.

GOOD: The color difference ΔE is smaller than or equal to 1.5

FAIR: The color difference ΔE is greater than or equal to 1.6 and smaller than or equal to 3.0

POOR: The color difference ΔE is greater than or equal to 3.1

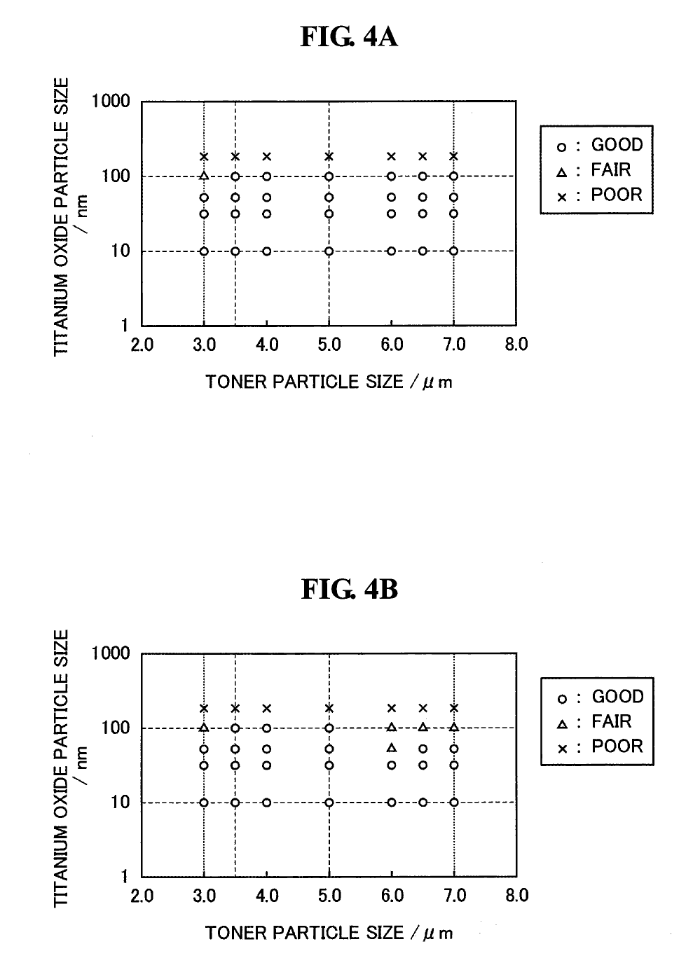

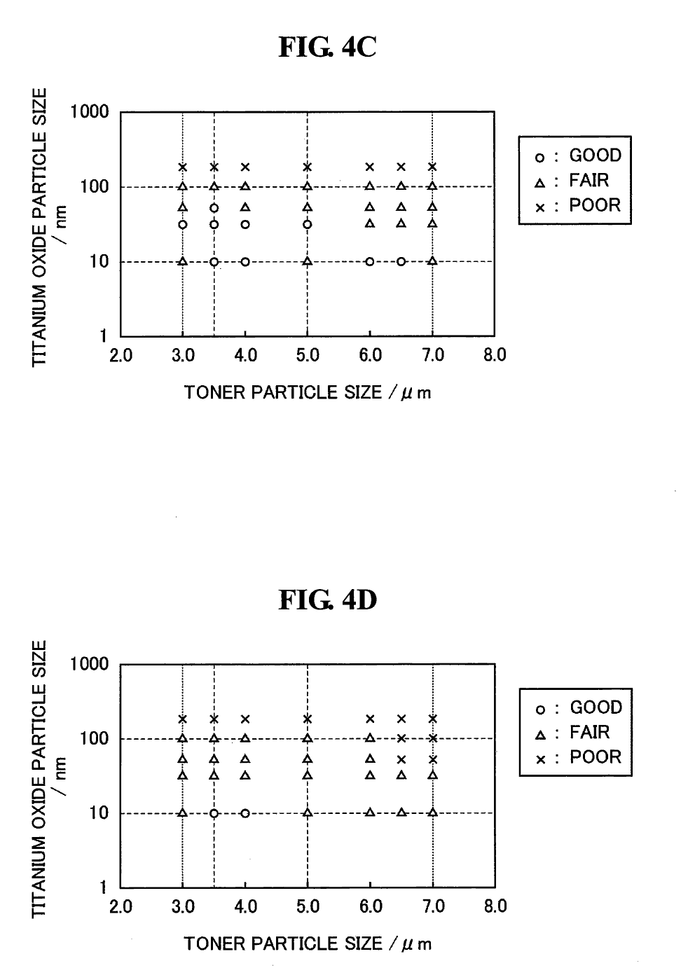

Referring to TABLEs 1 through 4, a result of the drum fog evaluation is stated. After the development device 20 including the toners A-1 through G-20 therein was left for one week, the drum fog was evaluated by the above described manner. In each of TABLEs 1 through 4, a “DRUM FOG ΔE” column represents the value obtained by calculation of the color difference ΔE, and a “FOG EVALUATION” column represents the evaluation result using the three ratings, GOOD, FAIR, and POOR. In addition to TABLEs 1 through 4, FIGS. 4A through 4D illustrate a correlation between the drum fog evaluation result and a toner particle size and a titanium oxide particle size with different amounts of the titanium oxide blended. FIGS. 4A through 4D respectively illustrate cases where 0.1 part by weight of the titanium oxide, 0.5 part by weight of the titanium oxide, 1.0 part by weight of the titanium oxide, and 1.5 parts by weight of the titanium oxide are blended with respect to 100 parts by weight of the toner.

TABLE 1

| | TONER | | TITANIUM OXIDE | | | | |
|---|---|---|---|---|---|---|---|
| | | PARTICLE | PARTICLE | | DRUM | | SPM |
| | | SIZE | SIZE | BLENDING | FOG | FOG | Rzjis |
| No. | NAME | [μm] | [nm] | AMOUNT | ΔE | EVALUATION | [nm] |
| EX. 1-1 | A-1 | 3.0 | 10 | 0.1 | 1.3 | GOOD | 54.1 |
| EX. 1-2 | A-2 | 3.0 | 10 | 0.5 | 0.7 | GOOD | 75.3 |
| EX. 1-3 | A-3 | 3.0 | 10 | 1.0 | 2.1 | FAIR | 101.5 |
| EX. 1-4 | A-4 | 3.0 | 10 | 1.5 | 2.5 | FAIR | 236.9 |
| EX. 1-5 | A-5 | 3.0 | 30 | 0.1 | 0.6 | GOOD | 84.2 |
| EX. 1-6 | A-6 | 3.0 | 30 | 0.5 | 0.4 | GOOD | 113.2 |
| EX. 1-7 | A-7 | 3.0 | 30 | 1.0 | 0.9 | GOOD | 156.9 |
| EX. 1-8 | A-8 | 3.0 | 30 | 1.5 | 3.0 | FAIR | 211.8 |
| EX. 1-9 | A-9 | 3.0 | 50 | 0.1 | 0.3 | GOOD | 81.1 |
| EX. 1-10 | A-10 | 3.0 | 50 | 0.5 | 1.1 | GOOD | 130.5 |
| EX. 1-11 | A-11 | 3.0 | 50 | 1.0 | 2.6 | FAIR | 175.2 |
| EX. 1-12 | A-12 | 3.0 | 50 | 1.5 | 2.3 | FAIR | 205.3 |
| EX. 1-13 | A-13 | 3.0 | 100 | 0.1 | 2.0 | FAIR | 75.3 |
| EX. 1-14 | A-14 | 3.0 | 100 | 0.5 | 2.2 | FAIR | 140.3 |
| EX. 1-15 | A-15 | 3.0 | 100 | 1.0 | 2.6 | FAIR | 170.9 |
| EX. 1-16 | A-16 | 3.0 | 100 | 1.5 | 2.9 | FAIR | 236.9 |
| COMP. EX. 1-1 | A-17 | 3.0 | 200 | 0.1 | 4.3 | POOR | 268.3 |
| COMP. EX. 1-2 | A-18 | 3.0 | 200 | 0.5 | 5.9 | POOR | 284.9 |
| COMP. EX. 1-3 | A-19 | 3.0 | 200 | 1.0 | 8.2 | POOR | 302.6 |
| COMP. EX. 1-4 | A-20 | 3.0 | 200 | 1.5 | 9.1 | POOR | 321.5 |
| EX. 1-17 | B-1 | 3.5 | 10 | 0.1 | 0.3 | GOOD | 81.2 |
| EX. 1-18 | B-2 | 3.5 | 10 | 0.5 | 1.3 | GOOD | 110.5 |
| EX. 1-19 | B-3 | 3.5 | 10 | 1.0 | 1.1 | GOOD | 154.2 |
| EX. 1-20 | B-4 | 3.5 | 10 | 1.5 | 1.3 | GOOD | 213.2 |
| EX. 1-21 | B-5 | 3.5 | 30 | 0.1 | 0.9 | GOOD | 81.6 |
| EX. 1-22 | B-6 | 3.5 | 30 | 0.5 | 1.1 | GOOD | 114.2 |
| EX. 1-23 | B-7 | 3.5 | 30 | 1.0 | 0.6 | GOOD | 173.4 |
| EX. 1-24 | B-8 | 3.5 | 30 | 1.5 | 2.6 | FAIR | 211.3 |
| EX. 1-25 | B-9 | 3.5 | 50 | 0.1 | 0.4 | GOOD | 84.3 |
| EX. 1-26 | B-10 | 3.5 | 50 | 0.5 | 1.1 | GOOD | 135.8 |
| EX. 1-27 | B-11 | 3.5 | 50 | 1.0 | 1.2 | GOOD | 168.9 |
| EX. 1-28 | B-12 | 3.5 | 50 | 1.5 | 2.3 | FAIR | 220.6 |
| EX. 1-29 | B-13 | 3.5 | 100 | 0.1 | 0.5 | GOOD | 84.9 |
| EX. 1-30 | B-14 | 3.5 | 100 | 0.5 | 1.3 | GOOD | 125.9 |
| EX. 1-31 | B-15 | 3.5 | 100 | 1.0 | 2.2 | FAIR | 189.3 |
| EX. 1-32 | B-16 | 3.5 | 100 | 1.5 | 2.5 | FAIR | 236.9 |
| COMP. EX. 1-5 | B-17 | 3.5 | 200 | 0.1 | 4.1 | POOR | 278.3 |
| COMP. EX. 1-6 | B-18 | 3.5 | 200 | 0.5 | 5.1 | POOR | 296.3 |
| COMP. EX. 1-7 | B-19 | 3.5 | 200 | 1.0 | 6.8 | POOR | 321.3 |
| COMP. EX. 1-8 | B-20 | 3.5 | 200 | 1.5 | 7.1 | POOR | 345.6 |

TABLE 2

| | TONER | | TITANIUM OXIDE | | | | |
|---|---|---|---|---|---|---|---|
| | | PARTICLE | PARTICLE | | DRUM | | SPM |
| | | SIZE | SIZE | BLENDING | FOG | FOG | Rzjis |
| No. | NAME | [μm] | [nm] | AMOUNT | ΔE | EVALUATION | [nm] |
| EX. 1-33 | C-1 | 4.0 | 10 | 0.1 | 0.2 | GOOD | 82.1 |
| EX. 1-34 | C-2 | 4.0 | 10 | 0.5 | 0.6 | GOOD | 110.3 |
| EX. 1-35 | C-3 | 4.0 | 10 | 1.0 | 1.2 | GOOD | 132.6 |
| EX. 1-36 | C-4 | 4.0 | 10 | 1.5 | 1.4 | GOOD | 198.3 |
| EX. 1-37 | C-5 | 4.0 | 30 | 0.1 | 0.5 | GOOD | 81.6 |
| EX. 1-38 | C-6 | 4.0 | 30 | 0.5 | 0.9 | GOOD | 119.3 |
| EX. 1-39 | C-7 | 4.0 | 30 | 1.0 | 1.4 | GOOD | 156.3 |
| EX. 1-40 | C-8 | 4.0 | 30 | 1.5 | 1.6 | FAIR | 203.4 |
| EX. 1-41 | C-9 | 4.0 | 50 | 0.1 | 0.8 | GOOD | 83.2 |
| EX. 1-42 | C-10 | 4.0 | 50 | 0.5 | 1.3 | GOOD | 127.4 |
| EX. 1-43 | C-11 | 4.0 | 50 | 1.0 | 1.7 | FAIR | 165.1 |
| EX. 1-44 | C-12 | 4.0 | 50 | 1.5 | 2.0 | FAIR | 205.9 |
| EX. 1-45 | C-13 | 4.0 | 100 | 0.1 | 1.3 | GOOD | 81.9 |
| EX. 1-46 | C-14 | 4.0 | 100 | 0.5 | 1.5 | GOOD | 140.3 |
| EX. 1-47 | C-15 | 4.0 | 100 | 1.0 | 1.9 | FAIR | 179.8 |
| EX. 1-48 | C-16 | 4.0 | 100 | 1.5 | 2.6 | FAIR | 230.9 |
| COMP. EX. 1-9 | C-17 | 4.0 | 200 | 0.1 | 3.3 | POOR | 256.3 |
| COMP. EX. 1-10 | C-18 | 4.0 | 200 | 0.5 | 3.9 | POOR | 301.3 |
| COMP. EX. 1-11 | C-19 | 4.0 | 200 | 1.0 | 5.6 | POOR | 330.9 |
| COMP. EX. 1-12 | C-20 | 4.0 | 200 | 1.5 | 6.4 | POOR | 359.4 |
| EX. 1-49 | D-1 | 5.0 | 10 | 0.1 | 0.3 | GOOD | 81.2 |
| EX. 1-50 | D-2 | 5.0 | 10 | 0.5 | 0.6 | GOOD | 123.5 |
| EX. 1-51 | D-3 | 5.0 | 10 | 1.0 | 1.6 | FAIR | 148.9 |
| EX. 1-52 | D-4 | 5.0 | 10 | 1.5 | 2.1 | FAIR | 189.3 |
| EX. 1-53 | D-5 | 5.0 | 30 | 0.1 | 0.5 | GOOD | 84.7 |
| EX. 1-54 | D-6 | 5.0 | 30 | 0.5 | 0.9 | GOOD | 127.6 |
| EX. 1-55 | D-7 | 5.0 | 30 | 1.0 | 1.5 | GOOD | 168.3 |
| EX. 1-56 | D-8 | 5.0 | 30 | 1.5 | 1.5 | GOOD | 213.2 |
| EX. 1-57 | D-9 | 5.0 | 50 | 0.1 | 0.8 | GOOD | 85.7 |
| EX. 1-58 | D-10 | 5.0 | 50 | 0.5 | 1.2 | GOOD | 138.7 |
| EX. 1-59 | D-11 | 5.0 | 50 | 1.0 | 1.8 | FAIR | 183.2 |
| EX. 1-60 | D-12 | 5.0 | 50 | 1.5 | 2.4 | FAIR | 211.4 |
| EX. 1-61 | D-13 | 5.0 | 100 | 0.1 | 1.1 | GOOD | 94.3 |
| EX. 1-62 | D-14 | 5.0 | 100 | 0.5 | 1.4 | GOOD | 213.2 |
| EX. 1-63 | D-15 | 5.0 | 100 | 1.0 | 2.6 | FAIR | 218.9 |
| EX. 1-64 | D-16 | 5.0 | 100 | 1.5 | 2.9 | FAIR | 236.9 |
| COMP. EX. 1-13 | D-17 | 5.0 | 200 | 0.1 | 4.0 | POOR | 289.1 |
| COMP. EX. 1-14 | D-18 | 5.0 | 200 | 0.5 | 4.1 | POOR | 325.0 |
| COMP. EX. 1-15 | D-19 | 5.0 | 200 | 1.0 | 4.5 | POOR | 356.9 |
| COMP. EX. 1-16 | D-20 | 5.0 | 200 | 1.5 | 4.9 | POOR | 403.2 |

TABLE 3

| | TONER | | TITANIUM OXIDE | | | | |
|---|---|---|---|---|---|---|---|
| | | PARTICLE | PARTICLE | | DRUM | | SPM |
| | | SIZE | SIZE | BLENDING | FOG | FOG | Rzjis |
| No. | NAME | [μm] | [nm] | AMOUNT | ΔE | EVALUATION | [nm] |
| EX. 1-65 | E-1 | 6.0 | 10 | 0.1 | 0.7 | GOOD | 75.3 |
| EX. 1-66 | E-2 | 6.0 | 10 | 0.5 | 1.1 | GOOD | 103.4 |
| EX. 1-67 | E-3 | 6.0 | 10 | 1.0 | 1.5 | GOOD | 159.3 |
| EX. 1-68 | E-4 | 6.0 | 10 | 1.5 | 2.5 | FAIR | 184.2 |
| EX. 1-69 | E-5 | 6.0 | 30 | 0.1 | 1.0 | GOOD | 82.8 |
| EX. 1-70 | E-6 | 6.0 | 30 | 0.5 | 1.4 | GOOD | 113.7 |
| EX. 1-71 | E-7 | 6.0 | 30 | 1.0 | 1.8 | FAIR | 162.3 |
| EX. 1-72 | E-8 | 6.0 | 30 | 1.5 | 2.1 | FAIR | 191.3 |
| EX. 1-73 | E-9 | 6.0 | 50 | 0.1 | 1.3 | GOOD | 84.9 |
| EX. 1-74 | E-10 | 6.0 | 50 | 0.5 | 1.8 | FAIR | 124.9 |
| EX. 1-75 | E-11 | 6.0 | 50 | 1.0 | 2.1 | FAIR | 179.3 |
| EX. 1-76 | E-12 | 6.0 | 50 | 1.5 | 2.5 | FAIR | 203.5 |
| EX. 1-77 | E-13 | 6.0 | 100 | 0.1 | 1.4 | GOOD | 82.9 |
| EX. 1-78 | E-14 | 6.0 | 100 | 0.5 | 2.3 | FAIR | 148.9 |
| EX. 1-79 | E-15 | 6.0 | 100 | 1.0 | 2.6 | FAIR | 179.5 |
| EX. 1-80 | E-16 | 6.0 | 100 | 1.5 | 3.9 | FAIR | 236.9 |
| COMP. EX. 1-17 | E-17 | 6.0 | 200 | 0.1 | 3.7 | POOR | 296.1 |
| COMP. EX. 1-18 | E-18 | 6.0 | 200 | 0.5 | 4.6 | POOR | 316.7 |
| COMP. EX. 1-19 | E-19 | 6.0 | 200 | 1.0 | 5.2 | POOR | 375.2 |
| COMP. EX. 1-20 | E-20 | 6.0 | 200 | 1.5 | 6.1 | POOR | 398.6 |
| EX. 1-81 | F-1 | 6.5 | 10 | 0.1 | 0.8 | GOOD | 76.8 |
| EX. 1-82 | F-2 | 6.5 | 10 | 0.5 | 0.6 | GOOD | 101.2 |
| EX. 1-83 | F-3 | 6.5 | 10 | 1.0 | 1.3 | GOOD | 138.9 |
| EX. 1-84 | F-4 | 6.5 | 10 | 1.5 | 1.6 | FAIR | 170.8 |
| EX. 1-85 | F-5 | 6.5 | 30 | 0.1 | 0.5 | GOOD | 80.1 |
| EX. 1-86 | F-6 | 6.5 | 30 | 0.5 | 0.8 | GOOD | 112.1 |
| EX. 1-87 | F-7 | 6.5 | 30 | 1.0 | 1.6 | FAIR | 165.3 |
| EX. 1-88 | F-8 | 6.5 | 30 | 1.5 | 2.9 | FAIR | 197.8 |
| EX. 1-89 | F-9 | 6.5 | 50 | 0.1 | 1.3 | GOOD | 84.3 |
| EX. 1-90 | F-10 | 6.5 | 50 | 0.5 | 1.1 | GOOD | 138.7 |
| EX. 1-91 | F-11 | 6.5 | 50 | 1.0 | 1.6 | FAIR | 219.4 |
| COMP. EX. 1-21 | F-12 | 6.5 | 50 | 1.5 | 3.3 | POOR | 250.3 |
| EX. 1-92 | F-13 | 6.5 | 100 | 0.1 | 1.0 | GOOD | 90.3 |
| EX. 1-93 | F-14 | 6.5 | 100 | 0.5 | 2.2 | FAIR | 178.9 |
| EX. 1-94 | F-15 | 6.5 | 100 | 1.0 | 2.8 | FAIR | 235.1 |
| COMP. EX. 1-22 | F-16 | 6.5 | 100 | 1.5 | 4.2 | POOR | 278.6 |
| COMP. EX. 1-23 | F-17 | 6.5 | 200 | 0.1 | 4.0 | POOR | 302.6 |
| COMP. EX. 1-24 | F-18 | 6.5 | 200 | 0.5 | 4.3 | POOR | 320.6 |
| COMP. EX. 1-25 | F-19 | 6.5 | 200 | 1.0 | 5.3 | POOR | 386.3 |
| COMP. EX. 1-26 | F-20 | 6.5 | 200 | 1.5 | 5.6 | POOR | 413.2 |

TABLE 4

| | TONER | | TITANIUM OXIDE | | | | |
|---|---|---|---|---|---|---|---|
| | | PARTICLE | PARTICLE | | DRUM | | SPM |
| | | SIZE | SIZE | BLENDING | FOG | FOG | Rzjis |
| No. | NAME | [μm] | [nm] | AMOUNT | ΔE | EVALUATION | [nm] |
| EX. 1-95 | G-1 | 7.0 | 10 | 0.1 | 0.6 | GOOD | 75.3 |
| EX. 1-96 | G-2 | 7.0 | 10 | 0.5 | 1.1 | GOOD | 101.3 |
| EX. 1-97 | G-3 | 7.0 | 10 | 1.0 | 2.0 | FAIR | 159.6 |
| EX. 1-98 | G-4 | 7.0 | 10 | 1.5 | 2.4 | FAIR | 236.9 |
| EX. 1-99 | G-5 | 7.0 | 30 | 0.1 | 0.5 | GOOD | 84.1 |
| EX. 1-100 | G-6 | 7.0 | 30 | 0.5 | 1.3 | GOOD | 112.3 |
| EX. 1-101 | G-7 | 7.0 | 30 | 1.0 | 1.6 | FAIR | 160.2 |
| EX. 1-102 | G-8 | 7.0 | 30 | 1.5 | 2.0 | FAIR | 223.1 |
| EX. 1-103 | G-9 | 7.0 | 50 | 0.1 | 0.8 | GOOD | 88.3 |
| EX. 1-104 | G-10 | 7.0 | 50 | 0.5 | 1.2 | GOOD | 145.9 |
| EX. 1-105 | G-11 | 7.0 | 50 | 1.0 | 2.5 | FAIR | 206.3 |
| COMP. EX. 1-27 | G-12 | 7.0 | 50 | 1.5 | 3.2 | POOR | 273.6 |
| EX. 1-106 | G-13 | 7.0 | 100 | 0.1 | 1.2 | GOOD | 75.3 |
| EX. 1-107 | G-14 | 7.0 | 100 | 0.5 | 2.4 | FAIR | 157.8 |
| EX. 1-108 | G-15 | 7.0 | 100 | 1.0 | 2.3 | FAIR | 236.9 |
| COMP. EX. 1-28 | G-16 | 7.0 | 100 | 1.5 | 3.6 | POOR | 258.9 |
| COMP. EX. 1-29 | G-17 | 7.0 | 200 | 0.1 | 4.0 | POOR | 318.6 |
| COMP. EX. 1-30 | G-18 | 7.0 | 200 | 0.5 | 5.1 | POOR | 342.6 |
| COMP. EX. 1-31 | G-19 | 7.0 | 200 | 1.0 | 5.6 | POOR | 385.6 |
| COMP. EX. 1-32 | G-20 | 7.0 | 200 | 1.5 | 6.7 | POOR | 400.6 |

As illustrated in TABLEs 1 through 4 and FIGS. 4A through 4D, an amount of the titanium oxide on the toner surface increases with an increase in the blending amount of the titanium oxide, causing not only an increase in the likelihood of liberation of the titanium oxide but also the drum fog. A toner having a relatively large particle size with a small surface area per unit volume tends to increase the likelihood of liberation of the titanium oxide and generation of the drum fog. However, a toner having a relatively small particle size with a large surface area per unit volume, for example, the toner A-4, can cause deterioration of the drum fog. The reduction in the particle size can decrease Van der Waals' force. Consequently, the decrease in the Van der Waals' force allows the external additives (e.g., the titanium oxide) to form an aggregate by attaching to one another and the aggregate to liberate, causing the deterioration of the drum fog.

According to the toners A-1 through G-20, where the titanium oxide having the particle size of 200 mm was used, each of the drum fog was evaluated as POOR based on the measurement of the blank sheet printed by the printer 100 after the development device 20 was left for one week. Where the toner had the particle size in a range of greater than or equal to 3.0 μm and smaller than or equal to 7.0 μm, and where the titanium oxide had the particle size in a range of greater than or equal to 10 nm and small than or equal to 100 nm, the drum fog was evaluated as any one of GOOD, FAIR, or POOR.

Where the toner had the volume average particle size of less than 3.0 μm, the drum fog was not evaluated due to a toner leakage from a seal portion of the development device 20. Where the toner having the volume average particle size of 8.0 μm was used for the printing, the drum fog was not evaluated due to unsatisfactory image quality. Particularly, the image quality was deteriorated due to poor graininess in the half-tone printing, so that the toner having the volume average particle size of 8.0 μm was determined as not capable of satisfying a demand of high quality and high-speed image formation with the electrophotographic method in years to come.

Since the drum fog could be caused by a surface state of the toner, the image with the toner A-1 was observed using a scanning probe microscope (“SPM-9600” available from Shimadzu Corp.). The measurement condictions are follows:

Cantilever: Nano-sensors (sprint constant of 42N/m, resonant frequency of 330 kHz, available from Shimadzu Corp.).

Cnatilever probe tip diameter: 10 nm

Measurement mode: Phase mode

Scanning range: 500 nm×500 nm

The toner A-1, for example, had a surface roughness value (Rzjis) of 54.1 nm based on the observation of a scanned image using the scanning probe microscope. Since the image was observed with respect to a very small region using the scanning probe microscope, the surface roughness value (Rzjis) of each of the toners was an average surface roughness value obtained from three sheets of the images, that is, the three sheets of the images were observed per toner to obtain the average value thereof as the surface roughness value (Rzjis). The “Rzjis” is applied based on JIS B601:2001 (“JIS” stands for Japanese Industrial Standards).

The toner A-1, for example, was evaluated as GOOD with regard to the drum fog. However, a blur occurred from approximately 5 cm from a bottom of the sheet having the solid black image formed using the toner A-1. Such a blur occurrence may be caused by inadequate toner conveyability due to a flat surface of the toner A-1. Similarly, the images formed using the toner A-2 through toner G-20 were observed as follows.

The image observation results obtained by the scanning probe microscope are shown in a “SPM Rzjis[nm]” column in TABLE 1. Where the drum fog was evaluated in the range of GOOD or FAIR, and where no blur was observed by the scanning probe microscope, the toner had Rzjis of greater than or equal to 75.3 nm and smaller than or equal to 236.9 nm. According to the toner having the Rzij of greater than or equal to 237.0 nm, on the other hand, the titanium oxide serving as the external additive is away from the toner mother particles, so that the titanium oxide is easier to liberate, causing a possibility of deterioration of the drum fog. According to the toner having the Rzij of greater than or equal to 237.0 nm, moreover, the toners having rough surfaces contact each other in the development device 20, so that the titanium oxide liberates, causing another possibility of deterioration of the drum fog.

Therefore, in a case where the development device 20 including the toner therein is left for one week after the printing operation, and then the printing operation is performed again, the toner capable of reducing the occurrences of the drum fog while not generating the blur is confirmed as follows: the toner having the volume average particle size of greater than or equal to 3.0 μm and smaller than or equal to 7.0 μm; the titanium oxide to be added having the particle size of greater than or equal to 10 nm and smaller than or equal to 100 nm; and the toner having the surface roughness Rzjis of greater than or equal to 75.3 nm and smaller than or equal to 236.9 nm obtained from the observation image by the scanning probe microscope.

Accordingly, the first embodiment can provide the toner capable of not only reducing the blur on the image but also reducing the occurrences of the drum fog by reducing the liberation of the titanium oxide caused by leaving the toner for a certain time period, for example, one week, after the printing operation where the toner has the volume average particle size of greater than or equal to 3.0 μm and smaller than or equal to 7.0 μm, where the titanium oxide to be added has the particle size of greater than or equal to 10 nm and smaller than or equal to 100 nm, and where the toner has the surface roughness Rzjis of greater than or equal to 75.3 nm and smaller than or equal to 236.9 nm obtained from the observation image (500 nm×500 nm) of the toner surface using the scanning probe microscope.

### Second Embodiment

A second embodiment of the present invention is similar to the first embodiment described above except for an intermittent feeding test which is described in detail below in Example 2. In the intermittent feeding test, a printing job is finished when one sheet is printed, and the printing is performed again. The intermittent feeding test was performed to each of the toners evaluated as GOOD with regard to the drum fog examined after the development device 20 was left for one week in the first embodiment described above.

### Example 2

The intermittent feeding test according to the second embodiment was performed as follows. First, an image having 5% Duty was intermittently printed. Second, a solid black image was printed on one sheet, a half-tone image serving as a 50% Duty image was printed on one sheet, and a blank sheet was printed on one sheet with respect to every 1000 sheets of the 5% Duty images. Generally, the toner having a relatively high toner layer potential tends to adhere to a non-printing portion (i.e., generating “smear”) under the conditions of low temperature and low humidity environment (temperature of 10 degrees Celsius and humidity of 20%). Accordingly, each of the intermittent feeding tests was performed under the low temperature and low humidity environment conditions. The intermittent feeding tests were performed with respect to 500 sheets per toner to evaluate the printing.

The evaluation was performed with respect to the “smear,” “streak,” and “graininess” criteria. Herein, the “streak” represents a vertical line or lines parallel to a sheet conveyance direction. According to the second embodiment, the streak represents a vertical line or lines parallel to a longitudinal direction relative to a sheet surface. The “graininess” represents a re-productability of a print dot. The printing was evaluated according to the following ratings.

GOOD for “smear”: No toner is adhered to the non-printing portion.

POOR for “smear”: Toner is adhered to the non-printing portion.

GOOD for “streak”: No streak (vertical line) is generated.

POOR for “streak”: Streak is generated (e.g., streak is generated on the solid black image and half-tone image to be collected with respect to every 1000 sheets).

GOOD for “graininess”: Half-tone image is clear, and a dot has a shape of close-to sphere based on observation using a magnifier.

POOR for “graininess”: Half-tone image is not clear, and a dust, for example, is found between the dots based on observation using the magnifier.

Referring to TABLEs 5 and 6, a result of the evaluation based on the above criteria is illustrated. According to the intermittent feeding test, the toner having no trouble in the “smear,” “streak,” and “graininess” criteria is determined as an example in TABLEs 5 and 6, while the toner having a trouble in at least one of the “smear,” “streak,” and “graininess” criteria is determined as a comparative example in TABLEs 5 and 6. Accordingly, the examples 2-1 through 2-35 and the comparative examples 2-1 through 2-31 are illustrated in TABLEs 5 and 6.

TABLE 5

| | TONER | | TITANIUM OXIDE | | | | | |
|---|---|---|---|---|---|---|---|---|
| | | PARTICLE | PARTICLE | | SPM | PRINT EVALUATION | | |
| | | SIZE | SIZE | BLENDING | Rzjis | OF CONTINUOUS TEST | | |
| No. | NAME | [μm] | [nm] | AMOUNT | [nm] | SMEAR | STREAK | GRAININESS |
| COMP. EX. 2-1 | A-1 | 3.0 | 10 | 0.1 | 54.1 | GOOD | POOR | GOOD |
| COMP. EX. 2-2 | A-2 | 3.0 | 10 | 0.5 | 75.3 | GOOD | POOR | GOOD |
| COMP. EX. 2-3 | A-5 | 3.0 | 30 | 0.1 | 84.2 | GOOD | POOR | GOOD |
| COMP. EX. 2-4 | A-6 | 3.0 | 30 | 0.5 | 113.2 | GOOD | POOR | GOOD |
| COMP. EX. 2-5 | A-7 | 3.0 | 30 | 1.0 | 156.9 | GOOD | POOR | GOOD |
| COMP. EX. 2-6 | A-9 | 3.0 | 50 | 0.1 | 81.1 | GOOD | POOR | GOOD |
| COMP. EX. 2-7 | A-10 | 3.0 | 50 | 0.5 | 130.5 | GOOD | POOR | GOOD |
| COMP. EX. 2-8 | B-1 | 3.5 | 10 | 0.1 | 81.2 | GOOD | POOR | GOOD |
| EX. 2-1 | B-2 | 3.5 | 10 | 0.5 | 110.5 | GOOD | GOOD | GOOD |
| EX. 2-2 | B-3 | 3.5 | 10 | 1.0 | 154.2 | GOOD | GOOD | GOOD |
| EX. 2-3 | B-4 | 3.5 | 10 | 1.5 | 213.2 | GOOD | GOOD | GOOD |
| EX. 2-4 | B-6 | 3.5 | 30 | 0.5 | 114.2 | GOOD | GOOD | GOOD |
| EX. 2-5 | B-7 | 3.5 | 30 | 1.0 | 173.4 | GOOD | GOOD | GOOD |
| EX. 2-6 | B-8 | 3.5 | 30 | 1.5 | 211.3 | GOOD | GOOD | GOOD |
| EX. 2-7 | B-11 | 3.5 | 50 | 1.0 | 168.9 | GOOD | GOOD | GOOD |
| EX. 2-8 | B-12 | 3.5 | 50 | 1.5 | 220.6 | GOOD | GOOD | GOOD |
| EX. 2-9 | B-13 | 3.5 | 100 | 0.1 | 84.9 | GOOD | GOOD | GOOD |
| EX. 2-10 | B-16 | 3.5 | 100 | 1.5 | 236.9 | GOOD | GOOD | GOOD |
| EX. 2-11 | B-17 | 3.5 | 200 | 0.1 | 278.3 | GOOD | GOOD | GOOD |
| EX. 2-12 | B-18 | 3.5 | 200 | 0.5 | 296.3 | GOOD | GOOD | GOOD |
| EX. 2-13 | C-1 | 4.0 | 10 | 0.1 | 82.1 | GOOD | GOOD | GOOD |
| EX. 2-14 | C-2 | 4.0 | 10 | 0.5 | 110.3 | GOOD | GOOD | GOOD |
| EX. 2-15 | C-3 | 4.0 | 10 | 1.0 | 132.6 | GOOD | GOOD | GOOD |
| EX. 2-16 | C-4 | 4.0 | 10 | 1.5 | 198.3 | GOOD | GOOD | GOOD |
| EX. 2-17 | C-5 | 4.0 | 30 | 0.1 | 81.6 | GOOD | GOOD | GOOD |
| EX. 2-18 | C-6 | 4.0 | 30 | 0.5 | 119.3 | GOOD | GOOD | GOOD |
| EX. 2-19 | C-7 | 4.0 | 30 | 1.0 | 156.3 | GOOD | GOOD | GOOD |
| EX. 2-20 | C-8 | 4.0 | 30 | 1.5 | 203.4 | GOOD | GOOD | GOOD |
| EX. 2-21 | C-11 | 4.0 | 50 | 1.0 | 165.1 | GOOD | GOOD | GOOD |
| EX. 2-22 | C-12 | 4.0 | 50 | 1.5 | 205.9 | GOOD | GOOD | GOOD |
| EX. 2-23 | C-16 | 4.0 | 100 | 1.5 | 230.9 | GOOD | GOOD | GOOD |
| EX. 2-24 | C-17 | 4.0 | 200 | 0.1 | 256.3 | GOOD | GOOD | GOOD |
| EX. 2-25 | D-1 | 5.0 | 10 | 0.1 | 81.2 | GOOD | GOOD | GOOD |
| EX. 2-26 | D-2 | 5.0 | 10 | 0.5 | 123.5 | GOOD | GOOD | GOOD |
| EX. 2-27 | D-4 | 5.0 | 10 | 1.5 | 189.3 | GOOD | GOOD | GOOD |
| EX. 2-28 | D-6 | 5.0 | 30 | 0.5 | 127.6 | GOOD | GOOD | GOOD |
| EX. 2-29 | D-7 | 5.0 | 30 | 1.0 | 168.3 | GOOD | GOOD | GOOD |
| EX. 2-30 | D-8 | 5.0 | 30 | 1.5 | 213.2 | GOOD | GOOD | GOOD |
| EX. 2-31 | D-9 | 5.0 | 50 | 0.1 | 85.7 | GOOD | GOOD | GOOD |
| EX. 2-32 | D-11 | 5.0 | 50 | 1.0 | 183.2 | GOOD | GOOD | GOOD |
| EX. 2-33 | D-12 | 5.0 | 50 | 1.5 | 211.4 | GOOD | GOOD | GOOD |
| EX. 2-34 | D-16 | 5.0 | 100 | 1.5 | 236.9 | GOOD | GOOD | GOOD |
| EX. 2-35 | D-17 | 5.0 | 200 | 0.1 | 289.1 | GOOD | GOOD | GOOD |
| COMP. EX. 2-9 | E-1 | 6.0 | 10 | 0.1 | 75.3 | GOOD | POOR | GOOD |
| COMP. EX. 2-10 | E-2 | 6.0 | 10 | 0.5 | 103.4 | GOOD | GOOD | POOR |
| COMP. EX. 2-11 | E-3 | 6.0 | 10 | 1.0 | 159.3 | GOOD | GOOD | POOR |
| COMP. EX. 2-12 | E-6 | 6.0 | 30 | 0.5 | 113.7 | POOR | GOOD | POOR |
| COMP. EX. 2-13 | E-7 | 6.0 | 30 | 1.0 | 162.3 | GOOD | GOOD | POOR |
| COMP. EX. 2-14 | E-11 | 6.0 | 50 | 1.0 | 179.3 | GOOD | GOOD | POOR |
| COMP. EX. 2-15 | E-16 | 6.0 | 100 | 1.5 | 236.9 | GOOD | GOOD | POOR |

TABLE 6

| | TONER | | TITANIUM OXIDE | | | | | |
|---|---|---|---|---|---|---|---|---|
| | | PARTICLE | PARTICLE | | SPM | PRINT EVALUATION | | |
| | | SIZE | SIZE | BLENDING | Rzjis | OF CONTINUOUS TEST | | |
| No. | NAME | [μm] | [nm] | AMOUNT | [nm] | SMEAR | STREAK | GRAININESS |
| COMP. EX. 2-16 | F-1 | 6.5 | 10 | 0.1 | 76.8 | POOR | POOR | POOR |
| COMP. EX. 2-17 | F-2 | 6.5 | 10 | 0.5 | 101.2 | GOOD | GOOD | POOR |
| COMP. EX. 2-18 | F-3 | 6.5 | 10 | 1.0 | 138.9 | GOOD | GOOD | POOR |
| COMP. EX. 2-19 | F-6 | 6.5 | 30 | 0.5 | 112.1 | POOR | GOOD | POOR |
| COMP. EX. 2-20 | F-7 | 6.5 | 30 | 1.0 | 165.3 | GOOD | GOOD | POOR |
| COMP. EX. 2-21 | F-11 | 6.5 | 50 | 1.0 | 219.4 | GOOD | GOOD | POOR |
| COMP. EX. 2-22 | F-12 | 6.5 | 50 | 1.5 | 250.3 | GOOD | GOOD | POOR |
| COMP. EX. 2-23 | F-16 | 6.5 | 100 | 1.5 | 278.6 | GOOD | GOOD | POOR |
| COMP. EX. 2-24 | G-1 | 7.0 | 10 | 0.1 | 75.3 | POOR | POOR | POOR |
| COMP. EX. 2-25 | G-2 | 7.0 | 10 | 0.5 | 101.3 | GOOD | GOOD | POOR |
| COMP. EX. 2-26 | G-3 | 7.0 | 10 | 1.0 | 159.6 | GOOD | GOOD | POOR |
| COMP. EX. 2-27 | G-7 | 7.0 | 30 | 1.0 | 160.2 | GOOD | GOOD | POOR |
| COMP. EX. 2-28 | G-8 | 7.0 | 30 | 1.5 | 223.1 | GOOD | GOOD | POOR |
| COMP. EX. 2-29 | G-12 | 7.0 | 50 | 1.5 | 273.6 | GOOD | GOOD | POOR |
| COMP. EX. 2-30 | G-13 | 7.0 | 100 | 0.1 | 75.3 | GOOD | GOOD | POOR |
| COMP. EX. 2-31 | G-17 | 7.0 | 200 | 0.1 | 318.6 | POOR | GOOD | POOR |

As illustrated in TABLEs 5 and 6, in a case where the toners of the examples 2-1 through 2-35 were used, the printing was evaluated as GOOD in all of the “smear,” “streak,” and “graininess” criteria, that is, no trouble, thereby obtaining a good printing result.

On the other hand, in a case where the toner of the comparison example 2-1 was used, for example, the streak was observed on an end portion (approximately 1 cm from a left sheet surface) of the black solid image in the printing of 1000 sheets in the intermittent feeding test. Here, a development blade 24 was removed for a visual observation, and a black adhered substance was observed. The black adhered substance was a toner melted and adhered to a blade in a position in which the streak was generated. In a case where the toner of the comparison example 2-2 was used as similar to the comparison example 2-1, two streaks were observed on an end portion (approximately 2 cm to 3 cm from the left sheet surface) of the black solid image in the printing of 3000 sheets in the intermittent feeding test. As similar to the comparison example 2-1 or 2-2, the adhered substances were observed in case of using the toner of the comparison examples 2-3 through 2-8 and the comparison example 2-9 as illustrated in TABLE 5, and such adhered substances were the toners melted and adhered to the development blade. Since each of the toners has a small particle size and is strongly aggregated to one another, the aggregate is sandwiched between the development blade 24 and the development roller 23 in the course of the intermittent feeding test, causing the generation of the streak.

Each of the toners of the comparison examples 2-10 through 2-31 had the toner particle size of greater than or equal to 6.0 μm, and the printing thereof was evaluated as POOR in the “graininess” criterion. Since each of such toners has a relatively large size, the dot is printed in a coarse manner. Moreover, the toner tends to be damaged by the intermittent feeding test. Consequently, the printing is evaluated as POOR in the “graininess” criterion.

For example, each of the comparison examples 2-16, 2-19, and 2-24 has a relatively small blending amount of the titanium oxide capable of reducing a charge amount of the toner, causing the generation of the “smear” by an increase in the charge amount of the toner.

The toners having a trouble in at least one of the “smear,” “streak,” and “graininess” criteria have the surface roughness Rzjis of less than 81.2 nm obtained from the image observation using the scanning probe microscope. The surface roughness Rzjis of less than 81.2 nm is greater than 213.2 nm. Accordingly, where the toner has the toner average volume particle size of greater than or equal to 3.5 μm and smaller than or equal to 5.0 μm, where the titanium oxide to be added has the particle size of greater than or equal to 10 nm and smaller than or equal to 100 nm, and where the surface roughness Rzjis obtained from the image observation using the scanning probe microscope is greater or equal to 81.2 nm and smaller than or equal to 213.2 nm, the likelihood of generating the “smear,” “streak,” and “graininess” can be reduced, so that good printing can be provided in the intermittent feeding test under the low temperature and low humidity environment.

According to the second embodiment, therefore, where the toner has the toner average particle size of greater than or equal to 3.5 μm and smaller than or equal to 5.0 μm, where the titanium oxide to be added has the particle size of greater than or equal to 10 nm and smaller than or equal to 100 nm, and where the surface roughness Rzjis obtained from the observation image (e.g., 500 nm×500 nm) using the scanning probe microscope is greater or equal to 81.2 nm and smaller than or equal to 213.2 nm, the likelihood of generating the “smear,” “streak,” and “graininess” can be reduced, so that good printing can be provided in the intermittent feeding test under the low temperature and low humidity environment in addition to the advantage of the first embodiment.

According to the first and second embodiments of the present invention described above, the printer 100 is described as the image forming apparatus. However, the embodiments of the present invention can be applied to an image forming apparatus such as a multi-functional peripheral (MFP), a facsimile machine, and a copier.

As can be appreciated by those skilled in the art, numerous additional modifications and variation of the present invention are possible in light of the above-described teachings. It is therefore to be understood that, within the scope of the appended claims, the disclosure of this patent specification may be practiced otherwise than as specifically described herein.

What is claimed is:

1. A developer comprising:
a toner including:
a toner mother particle having a resin and a colorant; and
an external additive to be added to a surface of the toner mother particle,
wherein the toner has a volume average particle size of greater than or equal to 3.0 μm and smaller than or equal to 7.0 μm and has a surface roughness Rzjis of greater than or equal to 75.3 nm and smaller than or equal to 236.9 nm under observation using a scanning probe microscope, and
wherein the external additive is titanium oxide having a particle size of greater than or equal to 10 nm and smaller than or equal to 100 nm.

2. The developer according to claim 1, wherein the volume average particle size is greater than or equal to 3.5 μm and smaller than or equal to 5.0 μm, and the surface roughness Rzjis is greater than or equal to 81.2 nm and smaller than or equal to 213.2 nm under observation using the scanning probe microscope.

3. The developer according to claim 1 is a non-magnetic developer.

4. The developer according to claim 1 is a one-component developer.

5. The developer according to claim 1, wherein the toner has a shape of sphere.

6. The developer according to claim 1, wherein the toner has an average degree of sphericity of greater than or equal to 0.97.

7. The developer according to claim 1, wherein the toner is produced by a suspension polymerization method.

8. A developer cartridge comprising:
a developer container storing therein a toner including a toner mother particle having a resin and a colorant and an external additive to be added to a surface of the toner mother particle,
wherein the toner has a volume average particle size of greater than or equal to 3.0 μm and smaller than or equal to 7.0 μm, and has a surface roughness Rzjis of greater than or equal to 75.3 nm and smaller than or equal to 236.9 nm under observation using a scanning probe microscope, and
wherein the external additive is titanium oxide having a particle size of greater than or equal to 10 nm and smaller than or equal to 100 nm.

9. The developer cartridge according to claim 8, wherein the volume average particle size is greater than or equal to 3.5 μm and smaller than or equal to 5.0 μm, and the surface roughness Rzjis is greater than or equal to 81.2 nm and smaller than or equal to 213.2 nm under observation using the scanning probe microscope.

10. The developer cartridge according to claim 8, wherein the developer container includes an agitation member disposed thereinside.

11. The developer cartridge according to claim 8, wherein the developer container communicates with an external portion through an opening, and
wherein the opening is open and closed by an open-close member.

12. A development device comprising:
a developer cartridge storing a developer; and
a development device main body including:
a developer carrier carrying the developer supplied from the developer cartridge; and
an image carrier provided with the developer supplied from the developer carrier,
wherein the developer includes a toner having a toner mother particle having a resin and a colorant and an external additive to be added to a surface of the toner mother particle,
wherein the toner has a volume average particle size of greater than or equal to 3.0 μm and smaller than or equal to 7.0 μm, and has a surface roughness Rzjis of greater than or equal to 75.3 nm and smaller than or equal to 236.9 nm under observation using a scanning probe microscope, and
wherein the external additive is titanium oxide having a particle size of greater than or equal to 10 nm and smaller than or equal to 100 nm.

13. The development device according to claim 12, wherein the volume average particle size is greater than or equal to 3.5 μm and smaller than or equal to 5.0 μm, and the surface roughness Rzjis greater than or equal to 81.2 nm and smaller than or equal to 213.2 nm under observation using the scanning probe microscope.

14. The development device according to claim 12, wherein the developer cartridge is detachably attached to the development device main body including the developer carrier and the image carrier.

15. The development device according to claim 12, wherein the developer carrier includes a metal core and a conductive elastic member disposed to an outer circumference of the metal core.

16. An image forming apparatus comprising:
a development device forming a developer image, the development device including:
a developer cartridge storing a developer; and
a development device main body,
a transfer unit transferring the development image formed by the development device to a recording medium; and
a fixing unit fixing the development image transferred by the transfer unit onto the recording medium,
wherein the developer includes a toner having a toner mother particle having a resin and a colorant and an external additive to be added to a surface of the toner mother particle,
wherein the toner has a volume average particle size of greater than or equal to 3.0 μm and smaller than or equal to 7.0 μm, and has a surface roughness Rzjis of greater than or equal to 75.3 nm and smaller than or equal to 236.9 nm under observation using a scanning probe microscope, and
wherein the external additive is titanium oxide having a particle size of greater than or equal to 10 nm and smaller than or equal to 100 nm.

17. The image forming apparatus according to claim 16, wherein the volume average particle size is greater than or equal to 3.5 μm and smaller than or equal to 5.0 μm, and the surface roughness Rzjis is greater than or equal to 81.2 nm and smaller than or equal to 213.2 nm under observation using the scanning probe microscope.

18. The image forming apparatus according to claim 16, wherein the development device is detachably attached with respect to the image forming apparatus.

19. The image forming apparatus according to claim 16, wherein the developer cartridge is detachably attached with respect to the image forming apparatus.
